(19) United States
(12) Patent Application Publication
(10) Pub. No.: US 2026/0342603 A1
(43) Pub. Date: Oct. 29, 2026

(54) ETHERNET INTERFACE WITH RAPID POWER TRANSITION CAPABILITY

(71) Applicant: Cisco Technology, Inc., San Jose, CA (US)

(72) Inventors: Thomas Helmut Toifl, Gattikon (CH); Aviran Kadosh, Moreshet (IL); Christian Ivo Menolfi, Langnau am Albis (CH); Danny Luu, Zurich (CH); Naor Goldman, Tzur Moshe (IL); Shai Erez, Tzofit (IL); Alessandro Cevrero, Zurich (CH); Liran Brecher, Kefar Sava (IL); Meir Peleg, Caesarea (IL); Rui Peng, Shanghai (CN); Lukas Kull, Cham (CH); Ilter Ismailov Hyuseinov, Adliswil (CH); Mor Levi, Gan Yavne (IL)

(21) Appl. No.: 19/192,316

(22) Filed: Apr. 28, 2025

(51) Int. Cl. H04L 12/12; H04L 7/10; H04L 25/03

(52) U.S. Cl. CPC H04L 12/12; H04L 7/10; H04L 25/03038

(57) ABSTRACT

Devices, systems, methods, and processes for facilitating a rapid power transition capability in an Ethernet interface are described herein. A transmitter is connected to a receiver over a communication link. A power management logic, deployed at the transmitter generates one or more control signals based on a transition of a transmission circuitry of the transmitter network device from a power-down mode to a power-up mode. The transmitter network device controls a transmission of a signal sequence through the transmission circuitry to the receiver based on the generated one or more control signals. The receiver transitions from the power-down mode to the power-up mode based on the received signal sequence, which includes a clock and data recovery (CDR) lock pattern and a start bit identifier. Data received over the communication link at the receiver is aligned based on the start bit identifier.

The present disclosure relates to wireless communication. More particularly, the present disclosure relates to power control management at Ethernet interface with rapid power transition capability.

### BACKGROUND

Conventional communication port architectures, such as those used in Ethernet interfaces, typically support continuous operation, where transmitter (TX) and receiver (RX) circuits remain active at all times regardless of data transmission activity. These communication port architectures prioritize constant readiness and link stability, often at the expense of energy efficiency.

To maintain continuous operation, such communication port keep analog and digital components powered and synchronized, even during periods of inactivity. Such approach based on continuous operation simplifies link management and minimizes latency for data transmission, but can result in sustained power consumption. In environments where communication activity is intermittent or data traffic is low, the always-on nature of these communication port leads to unnecessary energy usage. Further, the dependency on persistent biasing, clocking, and signal detection circuitry for continuous operation may contribute to a static power overhead.

### SUMMARY OF THE DISCLOSURE

Systems and methods for facilitating power control management at Ethernet interfaces with rapid power transition capability in accordance with embodiments of the disclosure are described herein. In many embodiments, a network device may include transmission circuitry communicatively coupled to a receiver over a communication link and a power management logic. The power management logic is configured to generate one or more control signals based on a transition of the transmission circuitry from a power-down mode to a power-up mode and control a transmission of a signal sequence through the transmission circuitry to the receiver based on the one or more control signals. The signal sequence is configured to cause the receiver to transition from the power-down mode to the power-up mode. In many embodiments, the opposite transition (e.g., transition from a power-up mode to a power-down mode) may be triggered by sending a known signal, such as an idle signal.

In a number of embodiments, the transmission circuitry corresponds to a Serializer/Deserializer transmitter.

In a variety of embodiments, the signal sequence comprises an initialization sequence, followed by a Clock and Data Recovery (CDR) lock pattern and a start bit identifier.

In further embodiments, the transmission circuitry comprises: an input section, a feed-forward equalizer circuit, and a first switching element coupled between the input section and the feed-forward equalizer circuit. The first switching element is configured to receive at least one control signal of the generated one or more control signals.

In still further embodiments, the first switching element comprises: a first input terminal, a second input terminal and coupled to the input section, an output terminal coupled to the feed-forward equalizer circuit. The first input terminal is configured to receive incoming data. The second input terminal is configured to receive a portion of the signal sequence. The first switching element is further configured to output at the output terminal one of the incoming data or the received portion of the signal sequence based on the received at least one control signal.

In more embodiments, the first switching element is further configured to output the received portion of the signal sequence based on the received at least one control signal switching from a first state to a second state.

In still more embodiments, the received portion of the signal sequence corresponds to at least one of a Clock and Data Recovery (CDR) lock pattern or a start bit identifier.

In additional embodiments, the first switching element comprises a multiplexer.

In still additional embodiments, the transmission circuitry comprises: an output section, a feed-forward equalizer circuit; and a second switching element coupled between the output section and the feed-forward equalizer circuit. The second switching element is configured to receive at least one control signal of the generated one or more control signals.

In numerous embodiments, the second switching element is configured to control a transmission functionality of the transmission circuitry based on the received at least one control signal.

In several embodiments, the controlling of the transmission functionality of the transmission circuitry comprises disabling the transmission functionality of the transmission circuitry based on the received at least one control signal switching from a first state to a second state.

In numerous additional embodiments, the disabling of the transmission functionality of the transmission circuitry occurs in the power-down mode.

In one or more embodiments, the controlling of the transmission functionality of the transmission circuitry comprises enabling the transmission functionality of the transmission circuitry based on the received at least one control signal switching from a second state to a first state.

In several additional embodiments, the enabling of the transmission functionality of the transmission circuitry occurs in the power-up mode.

In yet more embodiments, the second switching element comprises a multiplexer.

In still yet more embodiments, the transmission circuitry further comprises a digital to analog conversion (DAC) circuit coupled to the output section that is configured to generate one or more portions of the signal sequence based on a control signal of the generated one or more control signals.

In many further embodiments, the one or more portions of the signal sequence comprises an initialization sequence.

In still yet further embodiments, a network device may include a receiving circuitry communicatively coupled to a transmitter over a communication link and a power management logic. The power management logic is configured to receive a signal sequence from the transmitter, perform a clock and data recovery (CDR) lock based on the received signal sequence, and detect a start bit based on the CDR lock. The receiving circuitry is configured to receive data over the communication link and align the received data based on the detected start bit.

In yet several embodiments, the signal sequence comprises an initialization sequence, followed by a Clock and Data Recovery (CDR) lock pattern and a start bit identifier.

In numerous other embodiments, a method may include generating one or more control signals based on a transition of the transmitter device from a power-down mode to a power-up mode and controlling a transmission of a signal sequence through the transmission circuitry to a receiver based on the one or more control signals. The signal sequence is configured to cause the receiver to transition from the power-down mode to the power-up mode.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a networking environment in accordance with various embodiments of the disclosure;

FIG. 2 is a schematic diagram of a communication layer architecture in accordance with various embodiments of the disclosure;

FIG. 3 is a block diagram that illustrates a transmitter network device in accordance with various embodiments of the disclosure;

FIG. 4 is a block diagram that illustrates a receiver network device in accordance with various embodiments of the disclosure;

FIG. 5 is a diagram that illustrates a signal sequence in accordance with various embodiments of the disclosure;

FIG. 6 is a flowchart depicting a process for enabling rapid transition of power modes in accordance with various embodiments of the disclosure;

FIG. 7 is a flowchart depicting a process for implementing a selection of an output signal in accordance with various embodiments of the disclosure;

FIG. 8 is a flowchart depicting a process for switching to a selected output signal in accordance with various embodiments of the disclosure;

FIG. 9 is a flowchart depicting a process for generating control signals in accordance with various embodiments of the disclosure;

FIG. 10 is a flowchart depicting a process for managing a rapid power mode transition in accordance with various embodiments of the disclosure; and

FIG. 11 is a conceptual block diagram of a device suitable for configuration with a power management logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that can facilitate power control management at Ethernet interfaces. An Ethernet interface is a physical and logical connection that enables a device (for example, a computer, switch, router, or server) to communicate over an Ethernet network. The Ethernet interface may include a plurality of communication ports comprising hardware and software components that handle data transmission, reception, error detection, encoding/decoding, and flow control according to Ethernet standards. Each communication port of the Ethernet interface may be equipped with transmission (TX) circuitry and receiving (RX) circuitry that perform transmission and reception of data over the network. In many implementations, the TX circuitry and RX circuitry may include Serializer/deserializer (SerDes) circuits.

Communication port architectures typically support continuous operation, where TX and RX circuitries remain active and fully powered at all times. The communication ports maintain a constant readiness to transmit or receive data, with all supporting circuits, such as bias generators, clock recovery units, and analog front-end components, etc. remain engaged. As a result, even in the absence of data transmission, these communication ports maintain full activity. TX and RX circuitries continue to draw power, and supporting components remain operational, leading to unnecessary energy usage during idle periods. To improve energy efficiency, communication ports may be configured to enter a low-power or powered-down state when no data is being transmitted or received. In such implementations, the TX and RX circuitries, along with their associated components, may be powered off during inactivity and reactivated when data becomes available. However, transitioning between powered-down and powered-up states can introduce technical challenges. For example, bias circuits require time to stabilize, clock recovery units need to be re-locked to timing references, analog front-end components may need initialization before achieving full functionality, or the like. These processes can introduce latency, resulting in extended wake-up times that can limit the responsiveness of the communication port.

Therefore, to enable rapid power-up and power-down transitions of the TX and RX circuitries, the present disclosure provides a solution for power control management in Ethernet interfaces. More specifically, the present disclosure provides a network device configured to efficiently manage power consumption at an Ethernet interface by generating and executing one or more control signals for rapid transition between power up and power down modes. The network device may enter a low power mode when idle by shutting down one or more unused circuits of the Ethernet interface, while maintaining functionality to support quick wake-up. The network device may be a transmitter network device, a transmitter, a transceiver, or any other transmitting component in a communication network. The network device may include a power management logic configured to execute one or more power management operations. The power management logic may be equipped inside the network device or coupled to the network device. To prevent ambiguity, the network device may be referred to as the transmitter network device hereinafter.

In many embodiments, the transmitter network device may include a transmission circuitry that may be communicatively coupled to a receiver or a receiver network device via a communication link. In an example, the transmission circuitry may correspond to a Serializer/Deserializer (SerDes) transmitter and the receiver may include a SerDes receiver, both SerDes transmitter and SerDes receiver may have rapid power transition capabilities. A SerDes transmitter refers to a data transmission circuitry that converts parallel data into a serialized data stream, while a SerDes receiver refers to a data reception circuitry that converts a serialized data stream to parallel data.

In a variety of embodiments, the transmission circuitry may include an input section, a feed-forward equalizer circuit, and a first switching element coupled between the input section and the feed-forward equalizer circuit. The input section may be configured to receive incoming data from one or more source computing devices in an Ethernet network and buffer the incoming data for serialization. The feed-forward equalizer circuit may be configured to compensate for signal distortions by applying pre-emphasis or equalization to counteract inter-symbol interference (ISI) in the incoming data received by the input section. The first switching element may include a first input terminal coupled to the input section, a second input terminal coupled to the power management logic, and an output terminal coupled to the feed-forward equalizer circuit. The first switching element may also include a control terminal configured to receive a control signal that selects signals from one of the first input terminal or the second input terminal to be provided as output at the output terminal of the first switching element.

The transmission circuitry may further include an output section and a second switching element. The second switching element may be coupled between the output section and the feed-forward equalizer circuit. The output section may be configured to receive an output signal from the second switching element, and process the output signal before passing the output signal to a Digital-to-Analog Converter (DAC) circuit for final transmission. The second switching element may include a first input terminal coupled to the feed-forward equalizer circuit section, a second input terminal coupled to the power management signal, and an output terminal coupled to the output section. The second switching element may also include a control terminal configured to receive a control signal that selects signals from one of the first input terminal or the second input terminal to be provided as output at the output terminal of the second switching element. The first and the second switching elements may correspond to multiplexers (MUXs), or the like.

In various embodiments, the transmitter network device may generate a signal sequence to establish a reliable connection with the receiver network device before actual data transmission begins. The signal sequence may refer to a structured transmission pattern that includes, for example, an idle sequence, an initialization sequence, followed by a clock and data recovery (CDR) lock pattern, and a start bit identifier. The idle sequence may be series of idle symbols (for example, a sequence of 0s or 0 voltage signals) used when no data is transmitted to the receiver network device. In an example, the initialization sequence may refer to a predefined training sequence or handshaking signals used to wake up the receiver network device from the power-down mode and establish link synchronization. In an example, as part of initialization, the receiver network device may adjust one or more parameters such as equalization settings, gain control, or phase alignment based on the characteristics of the received initialization sequence. In further examples, the initialization sequence may correspond to a predefined ramp, step response, or pseudo-random binary sequence (PRBS) to initiate a wake-up sequence at the receiver network device. The initialization sequence may be followed by the CDR lock pattern or clock cycles for data locking. The CDR may refer to patterns (for example, C4, C8 patterns, preamble sequence, alternating edge patterns, specific bit sequences, hexadecimal sequences, or the like) that assist a CDR circuit of the receiver network device in acquiring and locking onto a timing of the CDR lock pattern. In an example, the CDR lock pattern may enable the receiver network device to extract correct timing information prior decoding actual data (e.g., payload) transmitted by the transmitter network device.

In yet various embodiments, the transmitter network device may generate the one or more control signals based on a transition of the transmission circuitry from the power-down mode to the power-up mode. The one or more control signals may be generated to control the first and the second switching elements for dynamic input selection (for example, selection between the first input terminal or the second input terminal), switch between clock sources for clock and data recovery, or regulate transitioning of power modes from the power-down mode to the power-up mode or vice versa. The transmitter network device may control a transmission of the signal sequence through the transmission circuitry to the receiver network device based on the generated one or more control signals. The signal sequence may be configured to cause the receiver network device to transition from the power-down mode to the power-up mode.

In more embodiments, the first switching element may be configured to receive incoming data at the first input terminal and a portion of the signal sequence at the second input terminal. The first switching element may be further configured to receive at least one control signal of the generated one or more control signals at the control terminal. Based on the received at least one control signal, the first switching element may be configured to output at the output terminal one of the incoming data or the received portion of the signal sequence. In other words, based on the received at least one control signal switching from a first state to a second state, the first switching element may select the second input terminal, and output the received portion of the signal sequence at the output terminal. In an example, the received portion of the signal sequence may correspond to a preamble sequence or the CDR lock pattern. On the contrary, if the received at least one control signal switches from the second state to the first state, the first switching element may be configured to select the first input terminal and output the incoming data at the output terminal.

In still more embodiments, the second switching element may be configured to receive at least one control signal of the generated one or more control signals at the control terminal of the second switching element. The second switching element may be configured to control a transmission functionality of the transmission circuitry based on the received at least one control signal. In other words, based on the received at least one control signal switching from a first state to a second state, the transmission functionality of the transmission circuitry may be disabled. The disabling of the transmission functionality of the second switching element may occur in the power-down mode. Disabling transmission functionality may lead to deactivating a transmission path of the transmission circuitry to put the transmitter network device into the power-down mode (for example, a low-power mode or idle state or sleep state) to conserve energy. On the contrary, based on the received at least one control signal switching from the second state to the first state, the transmission functionality of the transmission circuitry may be enabled. The enabling of the transmission functionality of the second switching element may occur in the power-up mode. Accordingly, enabling the transmission functionality of the transmission circuitry may lead to a series of events such as activating the transmission path of the transmission circuitry to resume signal transmission. Thus, the second switching element may enable a rapid turn off of the transmission path when there is no data to be transmitted and only turns on the transmission circuitry when there is data to be transmitted.

In yet more embodiments, the transmission circuitry may further include the DAC circuit coupled to the output section. The DAC circuit may be configured to generate one or more portions of the signal sequence. For example, the one or more portions of the signal sequence may include the initialization sequence, the start bit identifier, or the like.

In several embodiments, the receiver network device may include a receiving circuitry communicatively coupled to the transmitter network device over the communication link. The receiver network device may further include a power management logic configured to execute power control management during data reception. The power management logic may be equipped inside the network device. The receiver network device may be configured to receive the signal sequence from the transmitter network device. The signal sequence may include the initialization sequence, followed by the CDR lock pattern and the start bit identifier. The receiver network device may perform a CDR lock based on the received signal sequence and detect a start bit based on the CDR lock. In several more embodiments, the receiving circuitry may be configured to receive data over the communication link and align the received data based on the detected start bit.

Thus, the rapid power transition capabilities of the transmitter network device and the receiver network device may enhance energy efficiency, reduced latency, and improve system responsiveness by enabling swift transitions between active and low-power modes. Such rapid power transition capabilities may minimize power consumption in idle periods, extending device lifespan and reducing operational costs. Faster wake-up times enable seamless data transmission, making ethernet interface suitable for high-performance networking, cloud computing, and real-time applications. Additionally, quick power mode transitions help maintain link stability and synchronization to optimize overall network efficiency with uninterrupted communication.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the model purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (for example, chips, die, die planes, packages) or other discrete electrical devices, in electrical communication with one or more other components through electrical lines of a printed circuit board (PCB) or the like. Each of the functions and/or modules described herein, in still yet more embodiments, may alternatively be embodied by or implemented as a component.

A circuit, as used herein, comprises a set of one or more electrical and/or electronic components providing one or more pathways for electrical current. In many additional embodiments, a circuit may include a return pathway for electrical current, so that the circuit is a closed loop. In another embodiment, however, a set of components that does not include a return pathway for electrical current may be referred to as a circuit (for example, an open loop). For example, an integrated circuit may be referred to as a circuit regardless of whether the integrated circuit is coupled to the ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (for example, as firmware, a netlist, or the like). A circuit may comprise one or more silicon integrated circuit devices (for example, chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

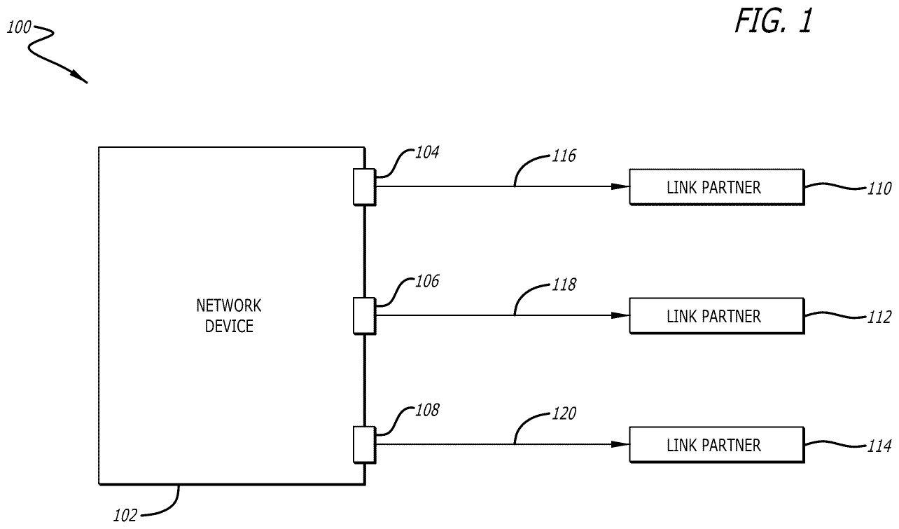

Referring to FIG. 1, a schematic block diagram of a networking environment 100 in accordance with various embodiments of the disclosure is shown. The embodiments depicted in FIG. 1 may show the networking environment 100 which can correspond to a network or a portion of the network. In many embodiments, the networking environment 100 may include a network device 102. The network device 102 may include hardware and/or software components that facilitate communication and transmission of data between computers or other network-enabled devices. In a network, the network device 102 may contribute to establishing and maintaining connections. Examples of the network device 102 may include a router, a switch, a hub, a modem, an access point, a server, a computing node, or the like. The network device 102 may include various ports that facilitate network connectivity. In a number of embodiments, the network device 102 may include a plurality of ports, of which ports 104-108 are shown. In a variety of embodiments, the ports 104-108 may correspond to communication ports of an Ethernet interface or simply Ethernet ports.

In more embodiments, the networking environment 100 may include a plurality of link partners associated with the network device 102, for example, via the ports 104-108. A link partner can correspond to a network device that couples to another network device via a network link. The network link may be a communication pathway that can couple two or more network devices, enabling data transmission between the network devices. In additional embodiments, the plurality of link partners may include link partners 110-114 associated with the ports 104-108, respectively. Examples of the link partners 110-114 may include Wireless Local Area Network (LAN) Controllers (WLCs), switches, access points, servers, modems, routers, Voice over Internet protocol (VoIP) devices, Internet of Things (IoT) devices, laptops, computers, or similar electronic devices.

As illustrated in FIG. 1, the link partner 110 may be coupled to the port 104 of the network device 102 by way of a link 116. Similarly, the link partner 112 may be coupled to the port 106 of the network device 102 by way of a link 118. Further, the link partner 114 may be coupled to the port 108 of the network device 102 by way of a link 120. In further embodiments, each link partner may include a port to facilitate coupling to a corresponding port of the network device. The network device 102 may, therefore, communicate with the link partners 110-114 by way of the links 116-120, respectively.

Traditionally, network devices have placed less emphasis on considering various aspects of operation that can relate to sustainability. To enhance sustainability, it may be beneficial to limit energy consumption, for example, by enabling the ports 104 108 to transition to a low power state when idle and resume full power state when data is to be transmitted/received. However, in many cases, multiple communication ports may power up or power down simultaneously, which can lead to network instability. This instability may result in link establishment failures due to excessive noise and interference, as well as abrupt power surges or drops.

To overcome the aforementioned issues, in the present disclosure, a Green Mode (GM) power saving technique may be executed at the network device 102 to enable power control management at Ethernet Interfaces. The GM power saving technique may be an advanced power-saving technique configured to reclaim Ethernet port power consumption during idle periods. According to the GM power saving technique, analog circuitry and some of the digital circuitry in a port may be powered down to save power when a network link associated with the port is idle. The GM power saving technique may be implemented to enable Ethernet devices, for example, the network device 102, to enter a low-power idle state when a network link, that connects the network device 102 to another network device, is idle. In an example, the GM power saving technique may power down both analog circuitry and portions of the digital circuitry, thereby substantially reducing idle power in the network device 102, for example, through the ports 104-108. For example, each of the ports 104-108 has a feature enabled for the GM. In an example, when a corresponding link partner (for example, the link partners 110-114) is not detected, the ports 104-108 may perform a power-down sequence to transition from a power-up mode to a power-down mode. In another example, when there is no data to be transmitted, for example, at any of the ports 104-108, ports 104-108 may perform the power-down sequence. In an example, the power-up mode may refer to an active power state during which a port may continue executing its operations. The power-down mode may refer to a low-power mode during idle conditions and may include shutting down unused circuits of the port, while maintaining functionality for a quick wake-up. Further, when the link partner 110 is detected or when data is available for transmission, the ports 104-108 may perform a power-up sequence to transition from the power-down mode to the power-up mode.

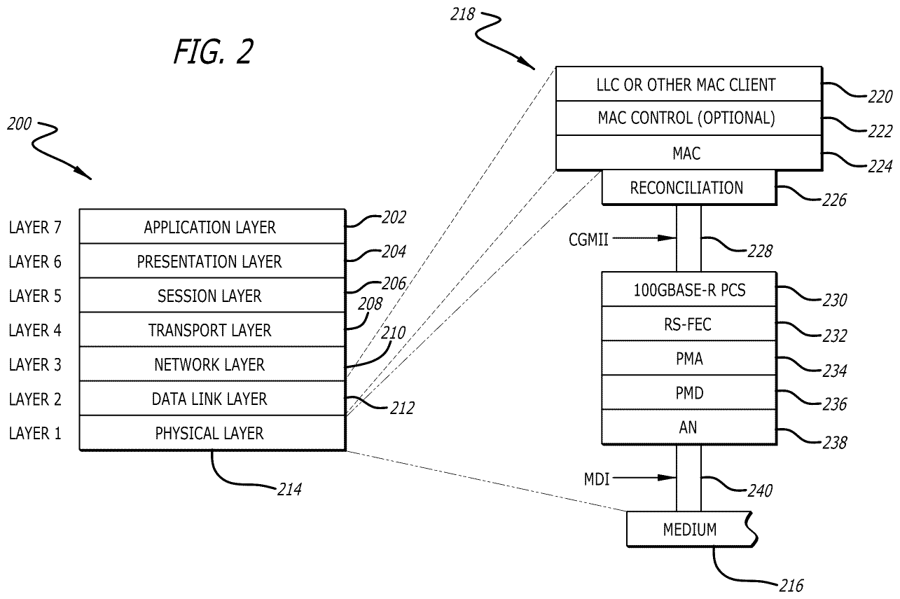

The quick transition to the power-up mode from the power-down mode may be enabled by transmitting a dedicated wake up signal sequence that allows the link partners 110-114 to rapidly synchronize and align with the network device 102 for data reception. The network device 102 may transmit the dedicated wake up signal sequence based on one or more control signals, which are described later in more detail in conjunction with FIG. 2-11.

Such power control management on network devices, for example, the network device 102 and the link partners 110-114 can be executed without manual intervention. As a result, idle power drawn may be reduced, while ensuring rapid link reactivation when data transmission resumes. Consequently, the energy consumed by the network device 102 and the link partners 110-114 may be lower than that consumed by conventional network devices.

Although a specific embodiment for the networking environment 100 is described above with respect to FIG. 1, any of a variety of systems and/or processes may be utilized in accordance with embodiments of the disclosure. For example, the networking environment 100 may include a different number of link partners coupled to an equivalent number of ports of the network device 102 by way of an equivalent number of links. The elements depicted in FIG. 1 may also be interchangeable with other elements of FIG. 2-11 as required to realize a particularly desired embodiment.

Referring to FIG. 2, a schematic diagram of a communication layer architecture 200 in accordance with various embodiments of the disclosure is shown. In many embodiments, the communication layer architecture 200 can be utilized to carry out various communications described or required herein. In a number of embodiments, the communication layer architecture 200 may be configured as an Open Systems Interconnection (OSI) model. In a variety of embodiments, the communication layer architecture 200 may include seven layers which may be implemented in accordance with the OSI model. The seven layers include, for example, a physical layer 214, a data link layer 212, a network layer 210, a transport layer 208, a session layer 206, a presentation layer 204, and an application layer 202.

In various embodiments, the physical layer 214 may serve as a foundational layer among the seven layers. The physical layer 214 may represent the first layer of the OSI model and may be referred to as “layer 1”. The physical layer 214 may be responsible for an actual physical connection between devices and transmission and reception of raw, unstructured data over a physical medium (denoted as “medium 216”) including, for example, cables such as twisted pair cables, fiber optic cables, backplane traces, or the like, or wireless connections. The physical layer 214 may include physical equipment involved in a data transfer and electrical/optical, mechanical, and functional interfaces to the physical medium. The physical layer 214 may carry signals for the higher layers of the OSI model. The physical layer 214 may provide synchronization of bits through a clock, define a transmission rate, that is, the number of bits transmitted per second, define an arrangement of different devices in a network, and define how the data flows between the two connected devices. The devices operating at the physical layer 214 may include network cables such as Ethernet cables, fiber optic cables, or the like, connectors, repeaters, hubs, or the like.

In more embodiments, the data link layer 212 may provide an error-free transfer of data frames from one device to another over the physical layer 214, allowing the layers 202-210 above the data link layer 212 to assume a substantially error-free transmission over a link. The data link layer 212 may represent the second layer of the OSI model and may be referred to as “layer 2”. The data link layer 212 may be configured to perform framing, error detection and correction, flow control, access control, and addressing. An example of a protocol utilized in the data link layer 212 may be Ethernet. Ethernet may operate in the physical layer 214 and the data link layer 212 of the OSI model. The data link layer 212 may be divided into two sublayers: a Logical Link Control (LLC) sublayer 220 and a Media Access Control (MAC) sublayer 224. The LLC sublayer 220 may manage communication between devices on the network and handle error correction, flow control, and data link management. The LLC sublayer 220 may be responsible for identifying and encapsulating higher-layer protocols such as an Internet Protocol (IP). The MAC sublayer 224 may control how the devices access the physical medium and transmit data. The MAC sublayer 224 may handle the addressing of the devices using MAC addresses, access control methods, and how to handle the data frames when they are ready for transmission. The devices that operate at the data link layer may include, for example, Network Interface Cards (NICs), switches, bridges, or the like. The data link layer may facilitate creation of a reliable point-to-point or point-to-multipoint link for data transmission between neighboring devices.

In additional embodiments, the network layer 210 may control the operation of a subnet, determining which physical path the data should take based on network conditions, priority of service, and other factors. The network layer 210 may represent the third layer of the OSI model and may be referred to as “layer 3”. The network layer 210 may perform logical addressing, routing, and the fragmentation and reassembly of data packets. In further embodiments, the network layer 210 may ensure that the data is directed from a source to a destination, even when the devices are not directly connected. An example of a protocol utilized in the network layer 210 may be IP. The devices that operate at the network layer 210 may include, for example, routers, for routing data between different networks or subnets. The network layer 210 may determine an optimal path for data to traverse through a network based on logical addressing. The network layer 210 may abstract the underlying physical layer 214 and the data link layer 212, allowing for a more scalable and flexible communication infrastructure.

In still more embodiments, the transport layer 208 may facilitate delivery of error-free messages, in sequence, and with no losses or duplications. The transport layer 208 may represent the fourth layer of the OSI model and may be referred to as “layer 4”. The transport layer 208 may be responsible for end-to-end communication between two devices. The transport layer 208 may also provide an acknowledgment of a successful data transmission and re-transmit data if an error is found. The transport layer 208 may segment and reassemble the data for transmission between the devices, perform error detection and correction, ensure flow control, and manage data transmission rates. Examples of protocols utilized in the transport layer 208 may include a Transmission Control Protocol (TCP), User Datagram Protocol (UDP), Point-to-Point Tunneling Protocol (PPTP), or the like.

In still further embodiments, the session layer 206 may be responsible for the establishment of connections, management of connections, and terminations of sessions between two devices. The session layer 206 may facilitate session establishment between processes running on different devices. The session layer 206 may represent the fifth layer of the OSI model and may be referred to as “layer 5”. The session layer 206 may synchronize data exchange, allowing for full-duplex, half-duplex, or simplex communication. The session layer 206 may allow a process to add checkpoints that are considered synchronization points in the data. These synchronization points may assist in identifying an error to allow a proper resynchronization of the data, to preclude ends of messages from being cut prematurely, and to avoid data loss. The session layer 206 may manage the sessions between two communicating devices, ensuring that data flows in the correct order.

In still additional embodiments, the presentation layer 204 may format the data for presentation to the application layer 202. The presentation layer 204 may represent the sixth layer of the OSI model and may be referred to as “layer 6”. The presentation layer 204 may be responsible for translation, encryption, and compression of data between the application layer 202 and the transport layer 208. The presentation layer 204 may be viewed as a translator for the network. The presentation layer 204 may translate data from a format utilized by the application layer 202 into a common format at a transmitting device and then translate the common format to a format known by the application layer 202 at a receiving device.

In some more embodiments, the application layer 202 may serve as a window for users and application processes to access network services and for displaying received information to the users. The application layer 202 may represent the seventh layer of the OSI model and may be referred to as “layer 7”. The application layer 202 may be implemented by network applications that generate the data to be transmitted over the network. Examples of protocols utilized in the application layer 202 may include a HyperText Transfer Protocol (HTTP), Simple Mail Transfer Protocol (SMTP), File Transfer Protocol (FTP), Domain Name System (DNS), or the like. The application layer 202 may directly interact with end-user applications. The application layer 202 may provide network services to the applications and facilitate user interaction with the network. In yet various embodiments, the application layer 202 may operate as a mediator, allowing different software applications to communicate seamlessly across the network.

Further, the Ethernet interface may be defined by the Institute of Electrical and Electronics Engineers (IEEE) as layers of functions as illustrated in FIG. 2, as captured from the IEEE802.3cx standard. The embodiments illustrated in FIG. 2 are described in the context of Ethernet layers 218 including, for example, a reconciliation layer 226, a MAC sublayer 224, an optional MAC control layer 222, an LLC sublayer 220, and higher layers 218. The optional MAC control layer 222, the LLC sublayer 220, and the higher layers 218 may be referred to as “upper layers 218-222.” The reconciliation layer 226, the MAC sublayer 224, and the upper layers 218-222 may process incoming and outgoing packets and may not operate when the link is idle, and no packets are transmitted or received. In lower layers that are below the reconciliation layer 226, the MAC sublayer 224, and the upper layers 218-222, the packets may be converted into a continuous stream of bits. These bits may be scrambled to guarantee frequent bit transitions from zero to one and vice versa. The continuous scrambled bits may imply that the lower layers are never idle. The lower layers may process the stream of bits even when they do not carry real data traffic. In yet more embodiments, the reconciliation layer 226 may communicate with the Ethernet PHY layer via a Common Gigabit Media Independent Interface (CGMII) 228. The Ethernet PHY layer may represent a physical layer device. In further embodiments, the reconciliation layer 226 may provide a mapping between signals available at the CGMII 228 and the MAC sublayer 224. In still further embodiments, the reconciliation layer 226 may adapt bit serial protocols of the MAC sublayer 224 to parallel encodings of a 100GBASE-R Physical Coding Sublayer (PCS) 230. The reconciliation layer 226 may convert parallel data from the MAC sublayer 224 into a serial data stream and convert serial data received from the Ethernet PHY layer into parallel data for the MAC sublayer 224. In an example, in a 100 Gbps Ethernet PHY layer, the reconciliation layer 226 may handle the process of converting parallel 25 Gbps data streams into a single serial data stream for transmission.

In still yet more embodiments, the CGMII 228 may operate at speeds, for example, up to 1000 Mbps, implemented using a data interface clocked at 125 megahertz (MHz) with separate eight-bit data paths for receive and transmit. In many further embodiments, the CGMII 228 may support a 100 Gbps operation through its 64-bit-wide transmit and receive data paths. In further additional embodiments, the CGMII 228 may support the 100 Gbps operation through its 256-bit wide transmit and receive data paths. The CGMII 228 may be an extension of a 10 Gigabit Media Independent Interface (XGMII) and a Gigabit Media Independent Interface (GMII), configured for 100GBASE-R Ethernet. The Ethernet PHY layer may include 100GBASE-R PCS 230, Reed Solomon-Forward Error Correction (RS-FEC) 232, a Physical Medium Attachment (PMA) 234, and a Physical Medium Dependent (PMD) sublayer 236. 100GBASE-R may represent a group or family of physical layer devices, for example, 100 Gbps transceivers, where “BASE” may refer to a baseband transmission method in which the entire bandwidth of the medium 216 may be utilized to transmit a single data stream without any frequency multiplexing, and “R” may indicate a use of serial transmission over high-speed links in the 100 Gigabit Ethernet (100GbE) standard. In still more embodiments, the 100GbE may follow a 64 b/66 b encoding scheme, instead of an older 8 b/10 b encoding, and may utilize the RS-FEC to enhance data integrity.

The 100GBASE-R PCS 230 may support, for example, a transmission of data at a rate of 100 Gbps. The 100GBASE-R PCS 230 may be responsible for encoding and decoding data to be transmitted over the medium 216. The 100GBASE-R PCS 230 may further perform block synchronization, lane distribution, and error detection to ensure reliable high-speed transmission. For 100GbE, the 100GBASE-R PCS 230 may perform 64 b/66 b encoding, which may improve efficiency compared to the older 8 b/10 b encoding by reducing overhead while maintaining synchronization. The 100GBASE-R PCS 230 may also implement RS-FEC for data integrity, for example, in high-speed, long-distance links. The 100GBASE-R PCS 230 may distribute data across multiple lanes, for example, 4 or 10 lanes in 100GBASE standards, and ensure proper lane alignment at a receiver network device.

The RS-FEC 232 may refer to a RS-FEC codeword-interleaved sublayer that may be utilized for error correction during the transmission of the data. In many additional embodiments, the Ethernet PHY layer may include the RS-FEC 232 based on the type of physical layer device. The PMA 234 may refer to a sublayer of the Ethernet PHY layer responsible for providing an interface between the Ethernet PHY layer and the medium 216. The PMA 234 may refer to a sublayer of the Ethernet PHY layer responsible for ensuring that the data is properly encoded or decoded for transmission over the medium 216. In many further embodiments, the PMA 234 may perform serialization, deserialization, clock recovery, and signal conditioning in Ethernet communication. The PMA 234 may receive parallel data from the 100GBASE-R PCS 230, converts the parallel data into a serial data stream, and transmit the serial data stream to the PMD for transmission over the medium 216. On the receiving end, the PMA 234 may perform Clock and Data Recovery (CDR) to extract an embedded clock signal and reassemble the serial data into a parallel format for the 100GBASE-R PCS 230. The PMA 234 may also support multi-lane architectures, such as 100GBASE-R, where the PMA 234 may distribute or multiplex data across multiple lanes before transmission. The PMA 234 may operate directly with the PMD sublayer 236 to transmit and receive the data, for example, across cables or optical fibers.

The PMD sublayer 236 may define the electrical, optical, or radio signals utilized for transmission, and specifications for physical connectors. The PMD sublayer 236 may define characteristics and properties, for example, signal levels, encoding schemes, or the like, of the medium 216, and how the transmission and reception of the data interact with this medium 216. In many additional embodiments, the PMD sublayer 236 may directly interface with the MDI 240 and convert digital signals from the PMA 234 into a format suitable for transmission, for example, over copper cables, fiber optics, or wireless channels. The PMD sublayer 236 may include, for example, laser drivers and photodetectors for optical links such as the 100GBASE-Short Range 4 (SR4)/Long Range 4 (LR4), or transmitters and receivers for electrical signals in copper-based Ethernet such as 100GBASE-Copper Ribbon 4 (CR4). The PMD sublayer 236 may also define key parameters such as signal levels, modulation schemes, and transmission distances, ensuring reliable communication over different media types.

In still yet further embodiments, the Ethernet PHY layer may implement an Auto-Negotiation (AN) protocol 238 based on the type of physical layer device. The AN protocol 238 may allow the devices on the network to automatically detect and agree on the best possible communication parameters such as speed and duplex mode based on the capabilities of both the devices. The AN protocol 238 may operate at the physical layer 214 to ensure that both the devices on the link can automatically agree on an optimal configuration for communication. The Ethernet PHY layer may communicate with the medium 216 via a Medium Dependent Interface (MDI) 240. The MDI 240 may be a physical connection point between the Ethernet PHY layer and the medium 216. The MDI 240 may define how a device physically connects to the medium 216 via the Ethernet interface and how signals are transmitted over that medium 216. The MDI 240 may specify whether the device is connected, for example, to an MDI-X (crossed wiring for a direct connection) or MDI (non-crossed, direct-to-device) interface. In various embodiments, the MDI 240 may include, for example, connectors, transceivers, and physical ports that are utilized for data transmission. For example, in a fiber-optic Ethernet, the MDI 240 may include optical connectors and transceiver modules that interface with the PMD sublayer 236. In a copper-based Ethernet, the MDI 240 may include Registered Jack-45 (RJ-45) connectors, for example, for twisted-pair cables or Direct-Attach Copper cables for high-speed links. The MDI 240 may ensure proper signal integrity and mechanical compatibility between network devices, allowing seamless connectivity across different Ethernet implementations through the medium 216.

The medium 216 may refer to a physical channel that transports Ethernet signals, and that can vary based on a specific Ethernet standard. The medium 216 may transport modulated signals, for example, electrical signals, optical signals, or wireless signals, between network devices, ensuring data integrity and minimal signal loss. The choice of the medium 216 may depend on speed, distance, interference resistance, and application requirements. The different types of the medium 216 may include, for example, an electrical copper medium utilized in twisted-pair cables such as Cat5e, Cat6, or Cat8 Ethernet cables, Direct-Attach Copper cables, or the like, a light-based, optical fiber medium utilized in a Single-Mode Fiber (SMF) and Multi-Mode Fiber (MMF) for long-distance high-speed communication, a wireless medium such as radio waves utilized in the IEEE 802.11 standard, millimeter Wave (mmWave), free-space optical communication, or the like.

In still yet additional embodiments, the systems, devices, and methods discussed herein perform power control management at the Ethernet interface described in the context of Ethernet layers illustrated in FIG. 2. In several embodiments, while the upper layers 218-222 may utilize clock gating techniques for reducing power consumption whenever there is no data traffic, the lower layers may continue to process incoming idle data patterns and consume power. The systems, devices, and methods discussed herein may provide a power management logic configured to power down the PMD sublayer 236 and the upper layers including, for example, the PMA 234, the RS-FEC 232, the 100GBASE-R PCS 230, the reconciliation layer 226, the MAC sublayer 224, and the upper layers 218-222. For example, the power management logic may be configured to execute a hop-by-hop protocol to power down a transmitter which in turn signals the associated receiver at a far end of a link to also power down. While powered down, the power management logic may perform a calibration to maintain the receiver clock synchronized to the remote transmitter clock. When new transmit data is present, the transmitter may power up and signal the receiver to power up as well. The systems, devices, and methods discussed herein may maintain a phase-locked loop in the receiver close to being locked for quick power-up time.

Although a specific embodiment for a communication layer architecture 200 is described above with respect to FIG. 2, any of a variety of systems and/or processes may be utilized in accordance with embodiments of the disclosure. For example, various aspects described herein may reside or be carried out on one layer, or a plurality of layers. The elements depicted in FIG. 2 may also be interchangeable with other elements of FIG. 1 and FIG. 3-11 as required to realize a particularly desired embodiment.

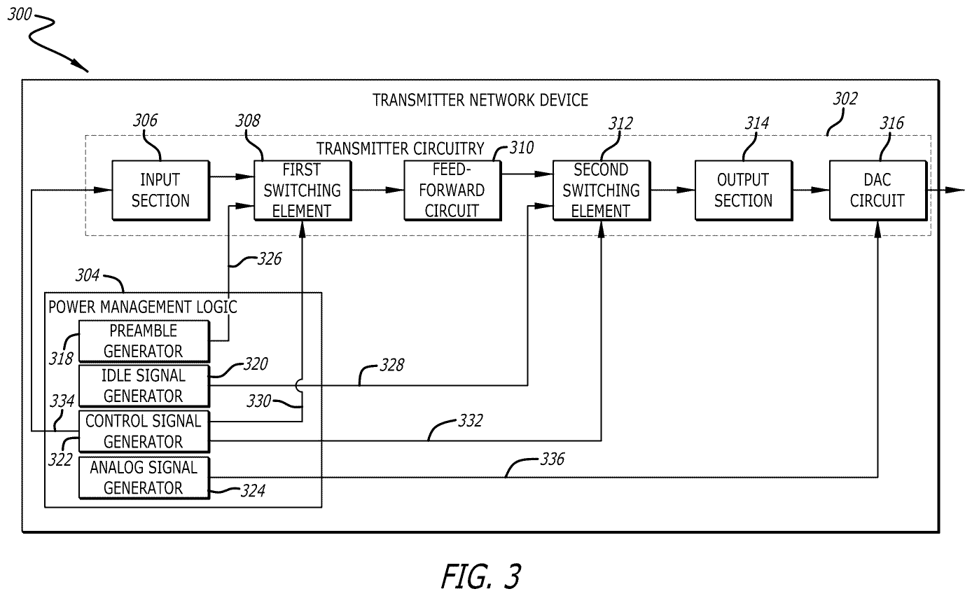

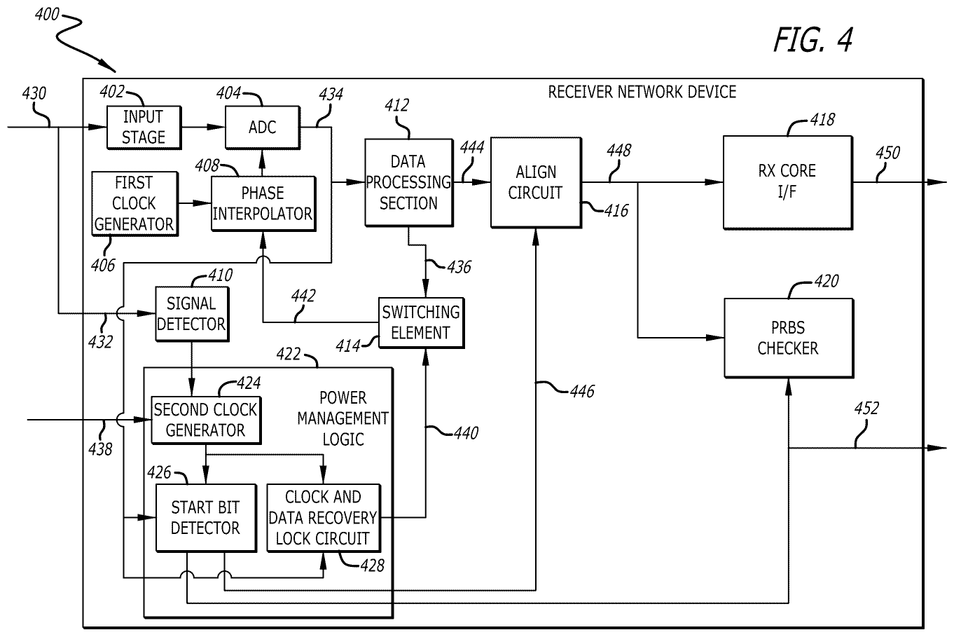

Referring to FIG. 3, a block diagram that illustrates a transmitter network device 300 in accordance with various embodiments of the disclosure is shown. In the example embodiment shown in FIG. 3, the transmitter network device 300 may incorporate an Ethernet interface. The transmitter network device 300 may be communicatively coupled to a receiver network device via a communication link. An example of the receiver network device is described later in conjunction with FIG. 4. The transmitter network device 300 may enable data transmission and link management over wired networks using physical and data link layer protocols to communicate with the receiver network device over the communication link. The transmitter network device 300 may be a transmitting device, a transceiver, or a transmitter that is configured to convert data from one or more host computing devices into electrical signals to transmit over the communication link to the receiver network device. In an example, the transmitter network device 300 may include or correspond to a Serializer/Deserializer (SerDes) transmitter. SerDes transmitter may refer to a transmission architecture that converts parallel data into a serial data stream for transmission over the communication link. The communication link may include, for example, twisted-pair cables, fiber-optic cables, and wireless connections in Wi-Fi networks. In an example, the communication link may be similar to any of the links 116 120.

In FIG. 3, the transmitter network device 300 is shown to include transmission circuitry 302 and a power management logic 304. The transmission circuitry 302 may implement a transmission path within the transmitter network device 300 and may include a sequence of functional blocks or circuits configured to prepare data for transmission to the receiver network device over the communication link. In an example, the transmission circuitry 302 may include, for example, formatting, encoding, serialization, and signal conditioning circuits, which collectively enable data transmission over the communication link.

Further, the power management logic 304 may be coupled to the transmission circuitry 302 and may be configured to implement power control management at the transmitter network device 300. The power management logic 304 can include various hardware and/or software deployments and can be configured in a variety of ways. For example, the power management logic 304 can be a set of instructions stored within a non-volatile memory that, when executed by processor(s) of the transmitter network device 300 can carry out the steps for power control management at the transmitter network device 300. In further examples, the power management logic 304 may correspond to a dedicated circuit (e.g., a microcontroller, a digital signal processor, or a similar processing unit) that generates control signals to enable a rapid power transition in the transmitter network device 300.

In many embodiments, the transmission circuitry 302 may include an input section 306, a first switching element 308, a feed-forward equalizer (FFE) circuit 310, a second switching element 312, an output section 314, and a Digital-to-Analog Converter (DAC) circuit 316. In an example, the input section 306, the first switching element 308, the FFE circuit 310, the second switching element 312, the output section 314, and the DAC circuit 316 may collectively enable the transmission path in the transmitter network device 300. In an example, the transmission circuitry 302 may implement at least a portion of a communication port of the transmitter network device 300, and the transmitter network device 300 can include any number of such communication ports.

In a number of embodiments, the input section 306 may be configured to receive parallel data from one or more host computing devices and perform initial data path processing on the parallel data, prior to transmission. Examples of the host computing devices may include, but are not limited to, a switch fabric, a MAC layer, or a central processing unit (CPU) interface. The input section 306 may include one or more functional elements such as, but not limited to, a core interface (IF), a pattern generator, a transmission (TX) link training element, a multiplexer, a bus arrangement element, a symbol mapping element, a differential precoder, or the like. These functional elements may be configured prepare input or incoming data (e.g., the parallel data) for subsequent equalization and conversion stages in the transmission circuitry 302.

In an example implementation of the input section 306, the core IF may be configured to receive incoming data, parallel data, control signals, and a reference clock from the host computing devices. Examples of the host computing devices may include, but are not limited to, a switch fabric, a MAC layer, or a central processing unit (CPU) interface. An output of the core IF may be coupled to the multiplexer. In addition to the core IF, the multiplexer may also be coupled to the pattern generator and the TX link training element. The pattern generator may be configured to generate test or diagnostic patterns, for example, during non-idle or active transmission modes and provide to the multiplexer. Further, the TX link training element may be configured to generate calibration sequences for calibration of the receiver network device and link training sequences for training the communication link, and provide these sequences to the multiplexer. At any given time instance during non-idle or active transmission modes, the multiplexer may be configured to allow an appropriate data stream forward along the transmission path. In other words, the multiplexer may select one of the core IF, the pattern generator, and the TX link training element as data source and forward the selected data stream (e.g., output of any of the core IF, the pattern generator, and the TX link training element that is selected) to the bus arrangement element. The bus arrangement element may be configured to align, segment, or reformat a bit-width of the data stream received from the multiplexer to match processing granularity of downstream transmission path.

Further, the output of the bus arrangement element may be coupled to the symbol mapping element. The symbol mapping element may be configured to encode the data stream received from the bus arrangement element into transmission-ready symbols based on a modulation scheme (such as Pulse Amplitude Modulation, Non-Return to Zero, or the like). In an example, one or more operations performed by the symbol mapping element may include encoding, scrambling, and/or mapping binary inputs to multi-level signal representations. The symbol mapping element may be coupled to the differential precoder and may provide the generated symbols to the differential precoder. The differential precoder may be configured to output precoded symbols by managing signal transitions and applying differential signal encoding to mitigate inter-symbol interference (ISI) and signal polarity mismatches. The differential precoder may provide the precoded symbols to the first switching element 308.

In an example, the first switching element 308 may correspond to a multiplexer (for example, but not limited to a 2:1 MUX, or the like). The first switching element 308 may be coupled between the input section 306 and the FFE circuit 310. The first switching element 308 may include a first input terminal coupled to the input section 306, a second input terminal coupled to the power management logic 304, and an output terminal coupled to the FFE circuit 310. The first input terminal of the first switching element 308 may receive an output of the input section 306. In an example where the output of the input section 306 corresponds to incoming data processed by the input section 306, the first input terminal of the first switching element 308 may receive the incoming data. In further examples, the first input terminal of the first switching element 308 can also receive signals or sequences generated by the pattern generator or the TX link training element of the input section 306. The second input terminal of the first switching element 308 may receive a portion of a signal sequence from the power management logic 304. In an example, the portion of the signal sequence received at the second input terminal of the first switching element 308 may correspond to a Clock and Data Recovery (CDR) lock pattern. The CDR lock pattern may refer to a pattern (for example, C4, C8 patterns, preamble sequence, alternating edge patterns, specific bit sequences, hexadecimal sequences) that enables a CDR circuit of the receiver network device in acquiring and locking onto a timing of the CDR lock pattern. In an example, the CDR lock pattern may enable the receiver network device to extract correct timing information prior decoding actual data (e.g., payload) transmitted by the transmitter network device.

The first switching element 308 may also include a control terminal configured to receive at least one control signal from the power management logic 304. Based on the at least one control signal, the first switching element 308 may select between the first input terminal (which receives an output from the input section 306) or the second input terminal (which may receive the portion of the signal sequence such as the CDR lock pattern from the power management logic 304). In other words, based on the at least one control signal, the first switching element 308 may output one of the incoming data (or the signals or sequences) received from the input section 306 or the portion of the signal sequence received from the power management logic 304 at the output terminal of the first switching element 308. In an example, the first switching element 308 may output the received portion of the signal sequence based on the at least one control signal switching from a first state to a second state or the at least one control signal having the second state. In further examples, the first switching element 308 may output the incoming data based on the at least one control signal having the first state.

The FFE circuit 310, coupled to the output terminal of the first switching element 308, may be configured to receive an output of the first switching element 308. In one example, the output of the first switching element 308 may correspond to the incoming data (or the signals or sequences) forwarded or output by the input section 306. Alternatively, the output of the first switching element 308 may correspond the portion of the signal sequence such as the CDR lock pattern.

The FFE circuit 310 may be configured to perform signal conditioning and equalization on the output of the first switching element 308. For example, the FFE circuit 310 may compensate for signal degradation due to channel impairments, such as attenuation, ISI, and frequency-dependent losses, that may occur in the transmission path of the transmitter network device 300 or over the communication link. In an example,

In an example implementation, the FFE circuit 310 may include a TX FFE, a TX resampler, a DAC line generator, or the like. The TX FFE, the TX resampler, and the DAC line generator may be configured to perform one or more operations for equalizing and correcting the received output of the first switching element 308. For the sake of brevity, the operations of the TX FFE, the TX resampler, the DAC line generator are described with regards to the incoming data. The TX FFE may be configured to process the incoming data received from the first switching element 308 for signal conditioning and equalization, while the TX resampler may be configured to resample the processed data to match timing requirements. The DAC line generator may be configured to convert the resampled data into precise analog voltage levels to shape and compensate the resampled data for any possible link impairments in the communication link. In more examples, the FFE circuit 310 can also include a loopback path (External Rx Loopback) that may be configured to provide a feedback or loopback mechanism with the receiver network device for signal testing or calibration. The resampled data from the FFE circuit 310 may be provided to the second switching element 312.

In an example, the second switching element 312 may correspond to a multiplexer (for example, a 2:1 MUX). The second switching element 312 may be coupled between the output section 314 and the FFE circuit 310. For example, the second switching element 312 may include a first input terminal coupled to the FFE circuit 310, a second input terminal coupled to the power management logic 304, and an output terminal coupled to the output section 314. The second switching element 312 may also include a control terminal configured to receive at least one control signal from the power management logic 304. In an example, the least one control signal received by the second switching element 312 may be different from the least one control signal received by the first switching element 308 from power management logic 304.

In a variety of embodiments, the second switching element 312 may be configured to control a transmission functionality of the transmission circuitry 302. Controlling the transmission functionality of the transmission circuitry 302 may include one of disabling or enabling the transmission functionality of the transmission circuitry 302. The second switching element 312 may control the transmission functionality of the transmission circuitry 302 based on the received at least one control signal. The at least one control signal received by the second switching element 312 may indicate whether the transmission circuitry 302 is in the power-up mode or the power-down mode by selecting which input terminal of the second switching element 312 is coupled to the output terminal of the second switching element 312.

For example, if the received at least one control signal switches from the second state to the first state or when the received at least one control signal is in the first state, the second switching element 312 may select the first input terminal, coupled to the FFE circuit 310, and provide an output of the FFE circuit 310 at the output terminal of the second switching element 312. In such a scenario, the second switching element 312 effectively couples the input section 306 through the first switching element 308 and the FFE circuit 310 to the output section 314, thereby enabling the transmission functionality of the transmission circuitry 302. However, if the received at least one control signal switches from the first state to the second state or when the received at least one control signal is in the second state, the second switching element 312 may select the second input terminal, coupled to the power management logic 304. In such a scenario, the second switching element 312 effectively decouples the input section 306 from the output section 314, thereby disabling the transmission functionality of the transmission circuitry 302. Disabling the transmission functionality may correspond to cutting off the data transmission path between the input section 306 and the output section 314.

In other words, the second switching element 312 may enable the transmission functionality of the transmission circuitry 302 based on the received at least one control signal switching from the second state to the first state or when the received at least one control signal is in the first state. The second switching element 312 may enable the transmission functionality in the power-up mode. Further, the second switching element 312 may disable the transmission functionality of the transmission circuitry 302 based on the received at least one control signal switching from the first state to the second state or when the received at least one control signal is in the second state. The second switching element 312 may disable the transmission functionality in the power-down mode.

In a scenario where the transmission functionality of the transmission circuitry 302 is enabled, the second switching element 312 may provide the output of the FFE circuit 310 to the output section 314. For example, the second switching element 312 may provide the resampled data received from the FFE circuit 310 to the output section 314. In further examples, the second switching element 312 may provide the portion of the signal sequence such as the CDR lock pattern received from the FFE circuit 310 to the output section 314. However, if the transmission functionality of the transmission circuitry 302 is disabled, the second switching element 312 may provide an idle sequence received at the second input terminal from the power management logic 304 to the output section 314. The idle sequence may include a series of idle symbols (for example, a series of 0s, a zero voltage signal, a zero energy signal, or the like) that are used when no data is transmitted to the receiver network device. It should be appreciated that this idle sequence may be detected by the RX, to bring or otherwise transition the RX to a power-down mode.

The output section 314, coupled to the output terminal of the second switching element 308, may be configured to receive an output of the second switching element 312. In one example, the output of the second switching element 312 may correspond to the output of the FFE circuit 310. Alternatively, the output of the second switching element 312 may correspond to the idle sequence.

In an example implementation, the output section 314 may include a TX Auto Negotiation (AN) element that may be configured to handle a negotiation process between the transmitter network device 300 and the receiver network device to determine one or more optimal transmission parameters, such as speed and encoding scheme. The output section 314 can also include an adder (+) circuit that may be configured to combine multiple weighted signal components or offsets, such as equalized data from the FFE circuit 310, to generate final data to be transmitted. The output section 314 may also include a multiplexer to output the final data after combining the one or more optimal transmission parameters with the combined weighted signal components. Further, the output section 314 may include a thermo-code generator that may be configured to convert binary data into a thermometer-coded format, which may be useful for DAC implementations to reduce glitches and improve linearity. In an example, the TX AN element, the adder circuit, the multiplexer, and the thermos-code generator may collectively form the output section 314. The output section 314 may be further coupled to the DAC circuit 316.

In an example, the DAC circuit 316 may be configured to receive an output of the output section 314 which can vary during different modes. For example, during the power-up mode, the DAC circuit 316 may receive the incoming data (e.g., processed version of the incoming data) for transmitting to the receiver network device. During the power-down mode, the DAC circuit 316 may receive the idle sequence to transmit to the receiver network device. During a transition from the power-down mode to the power-up mode, the DAC circuit 316 may be configured to receive at least some portions of the signal sequence to transmit to the receiver network device to wake up the receiver network device from the power-down mode to the power-up mode. In further embodiments, the DAC circuit 316 may be further coupled to the power management logic 304 and configured to receive at least one control signal from the power management logic 304. One or more operations of the DAC circuit 316 may be controlled based on the at least one control signal received from the power management logic 304.

In more aspects, the power management logic 304 may be configured to manage a rapid power mode transition capability of the transmission circuitry 302. Further, the power management logic 304 may be configured to generate one or more control signals and control a transmission of the signal sequence through the transmission circuitry 302 based on the one or more control signals. The signal sequence may refer to a structured transmission pattern that may include the idle sequence, an initialization sequence, followed by the CDR lock pattern (e.g., preamble), and a start bit identifier. The signal sequence, when transmitted, may function as a trigger for the receiver network device to wake up from the power-down mode, for calibration or data reception. In an example, the power management logic 304 may generate the one or more control signals based on a transition of the transmission circuitry 302 from the power-down mode to the power-up mode. In other words, the one or more control signals generated during a transition phase of the transmission circuitry 302 from the power-down mode to the power-up mode may cause the transmission circuitry 302 to transmit the signal sequence to the receiver network device. In one or more embodiments, the transmitter network device 300 may transmit the signal sequence to establish a reliable connection with the receiver network before actual data transmission begins.

In several aspects, the power management logic 304 may include a preamble generator 318, an idle signal generator 320, a control signal generator 322, and an analog signal generator 324 to manage the rapid power mode transition capability of the transmission circuitry 302, and in turn the receiver network device. In yet more embodiments, the preamble generator 318 may be configured to generate a preamble sequence 326. The preamble sequence 326 may refer to a predefined sequence of bits or symbols used at the beginning of a transmission to help the receiver network device to achieve synchronization and establish clock recovery. The preamble sequence 326 may correspond to the CDR lock pattern. The preamble sequence 326 generated by the preamble generator 318 may be provided to the second input terminal of the first switching element 308. In still more embodiments, the idle signal generator 320 may generate the idle sequence when no active data is being sent. The idle sequence 328 generated by the control signal generator 322 may be provided to the second input terminal of the second switching element 312.

In still yet more embodiments, the control signal generator 322 and the analog signal generator 324 may be configured to generate the one or more control signals for managing power mode transitions, data flow, and link training between the transmitter network device 300 and the receiver network device. In an example, the control signal generator 322 may generate a first control signal 330, a second control signal 332, and a third control signal 334 of the one or more control signals. The first control signal 330 and the second control signal 332 may be provided to the control terminals of the first switching element 308 and the second switching element 312, respectively. Further, the third control signal 334 may be provided to the input section 306, for example, to the pattern generator in the input section 306. In numerous embodiments, the analog signal generator 324 may be configured to generate an analog signal 336 of the one or more control signals to control waking up or shutting down the DAC circuit 316.

In an example scenario, the first control signal 330 and the second control signal 332 may be generated by the power management logic 304 to control the first and second switching elements 308 and 312 for dynamic lane selection (for example, selection between the first input terminal or the second input terminal).

In additional embodiments, in the power-down mode, the first control signal 330 may be in the first state, such as a logic low level, thereby causing the first switching element 308 to select corresponding first input terminal, which may be coupled to the input section 306. In this state, the input section 306 may not provide any payload data and may instead provide an idle sequence, which may correspond to a constant low-voltage pattern or a predefined null data symbol. Simultaneously, the second control signal 332 may be in the second state, such as a logic high level, thereby causing the second switching element 312 to select corresponding second input terminal, which may be coupled to the idle signal generator 320. As a result, the input section 306 may be decoupled from the output section 314, and the transmission functionality of the transmission circuitry 302 may be disabled. Additionally, the analog signal 336, which may be generated by the analog signal generator 324 may be in a logic state that maintains the DAC circuit 316 in an inactive or deactivated state.

Upon detection of valid data availability at the input section 306 or based on higher-level system control, the transmission circuitry 302 may transition from the power-down mode to the power-up mode. In response to the transition from the power-down mode to the power-up mode, the power management logic 304 may be configured to update the one or more control signals in a manner that causes the transmission of the signal sequence to the receiver network device. In many additional embodiments, the analog signal generator 324 may transition the analog signal 336 to a logic state that activates the DAC circuit 316. Further, the control signal generator 322 may transition the second control signal 332 from the second state to the first state, thereby causing the second switching element 312 to select corresponding first input terminal, which is coupled to the output of the FFE circuit 310. As a result, the input section 306 becomes functionally coupled to the output section 314 through the FFE circuit 310 and the second switching element 312, and the transmission functionality of the transmission circuitry 302 becomes enabled.

The power management logic 304 may cause the initialization sequence to be transmitted to the receiver network device. The initialization sequence may include a high voltage stream, a step signal, a pulse train, or a repetitive digital pattern (such as a hexadecimal sequence or binary ramp), which can produce a deterministic output from the DAC circuit 316 with strong amplitude and clear edge characteristics. In many further embodiments, the power management logic 304 may cause the DAC circuit 316 to generate and transmit the initialization sequence. In many examples, when the transmission circuitry 302 is fully active or clocked, the control signal generator 322 may drive the third control signal 334 in a manner that causes a stream of maximum voltage to be transmitted from the input section 306 to the DAC circuit 316, which may cause the DAC circuit 316 to generate and transmit the initialization sequence. In other words, the DAC circuit 316 may generate one or more portions (e.g., the initialization sequence) of the signal sequence based on at least one control signal (e.g., the third control signal 334) the one or more control signals generated by the power management logic 304. The change from the idle sequence to the initialization sequence may indicate a transmission activity, which may wake up the receive network device.

After the transmission of the initialization sequence, the power management logic 304 may cause the CDR lock pattern and the start bit identifier to be transmitted to the receiver network device. The power management logic 304 may configure the first control signal 330 to transition from the first state to the second state. As a result, the first switching element 308 may select corresponding second input terminal, which may be coupled to the preamble generator 318. The first switching element 308 may then output the preamble sequence 326, which may include the CDR lock pattern followed by the start bit identifier, received from the preamble generator 318. The preamble sequence 326 may thus be forwarded to the FFE circuit 310 and passed through the second switching element 312 to the output section 314 and the DAC circuit 316. The DAC circuit 316 may convert the preamble sequence 326 into an analog signal and transmit over the communication link. In several more embodiments, the start bit identifier may be a unique symbol or bit pattern, such as a single transition from a known repetitive pattern or a reserved bit value that does not occur in the CDR lock pattern. This start bit identifier may be configured to enable the identification of an end of the CDR lock pattern and a beginning of the payload data. For example, after several cycles of a C8 clock pattern, the occurrence of a non-repetitive symbol or a specific binary bit value (e.g., “1010”, “1111”, or “0”) may signal the start bit identifier.

Following the transmission of the CDR lock pattern and the start bit identifier, the power management logic 304 may further re-configure the first control signal 330 to return to the first state. As a result, the first switching element 308 may reselect corresponding first input terminal, thereby allowing processed data from the input section 306 to be transmitted through the transmission circuitry 302 to the receiver network device.

Although a specific embodiment for the transmitter network device 300 suitable for carrying out the various steps, processes, methods, and operations described herein is discussed with respect to FIG. 3, any of a variety of systems and/or processes may be utilized in accordance with embodiments of the disclosure. For example, to transmit the initialization sequence, the analog signal generator 324 may drive the analog signal 336 to provide a constant or a pre-configured signal (e.g., a maximum amplitude) to the DAC circuit 316. In such a case, the DAC circuit 316 may generate and transmit the initialization sequence even when a digital section of the transmission circuitry 302 (such as the input section 306, the FFE circuit 310, and the output section 314) are not yet fully active or clocked. Such an approach may offer reduced latency and power consumption by avoiding early digital startups and instead relying on analog path control for generating and transmitting the initialization sequence. In other words, the simultaneous waking up of both the digital and analog section of the transmission circuitry 302 may enable a rapid powering up of the transmitter network device 300, and in turn the receiver network device. A detailed description is provided in the following section. The elements depicted in FIG. 3 may also be interchangeable with other elements of FIG. 1-2 and FIG. 4-11 as required to realize a particularly desired embodiment.

Referring to FIG. 4, a block diagram that illustrates a receiver network device 400 in accordance with various embodiments of the disclosure is shown. The receiver network device 400 may be implemented as a receiving device, a receiver, a receiver module, or a transceiver communicatively coupled to a transmitter network device via a communication link. The receiver network device 400 may include receiving circuitry configured to detect, recover, and decode incoming data (also referred to as payload data), while maintaining synchronization, performing CDR, and enabling data alignment for processing.

In many embodiments, the receiving circuitry in the receiver network device 400 may include an input stage 402, an analog to digital converter (ADC) 404, a first clock generator 406, a phase interpolator (PI) 408, a signal detector 410, a data processing section 412, a switching element 414, an align circuit 416, a receiver (RX) core interface (I/F) 418, and a PRBS checker 420. The receiving circuitry may further include a power management logic 422, including a second clock generator 424, a start bit detector 426, and a CDR lock circuit 428.

In various embodiments, the input stage 402 may be coupled to the ADC 404, which may be coupled to the data processing section 412. The data processing section 412 may be coupled to the switching element 414 and to the align circuit 416. The align circuit 416 may be coupled to the RX core I/F 418 and the PRBS checker 420. The switching element 414 may be coupled to the PI 408, which may be coupled to the ADC 404. The PI 408 may also be coupled to the first clock generator 406. The signal detector 410 may be coupled to the power management logic 422, for example, the second clock generator 424. The start bit detector 426 may be coupled to the align circuit 416 and the PRBS checker 420. The CDR lock circuit 428 may be coupled to the switching element 414.

In a variety of embodiments, the input stage 402 may be configured to receive a signal 430 from the transmitter network device. The signal 430 may be converted to a digital signal 434 by the ADC 404. In a non-limiting example, the ADC 404 may convert the signal 430 into a 64×7-bit digital signal. The first clock generator 406 may be configured to provide a reference clock signal for the receiver network device 400. In some embodiments, the first clock generator 406 may correspond to an external clock that is never turned off. In other words, the first clock generator 406 may provide a continuous reference clock signal for the receiver network device 400. In a non-limiting example, the first clock generator 406 may correspond to a 14 Giga-Hertz (GHz) clock generator that may provide a 14 GHz reference clock signal for the receiver network device 400.

The PI 408 may be configured to align a phase of the reference clock signal with the received signal 430 to generate the digital signal 434. For example, aligning the phase of the reference clock signal with the received signal 430 may enable various sampling instants of the ADC 404 to be accurately positioned relative to transitions in the received signal 430. To align the phase of the reference clock signal with the received signal 430, the PI 408 may detect a clock pattern within the received signal 430 and adjust the phase of the reference clock signal, for example, over a full 0 to 360 degrees range. Additionally or alternatively, the PI 408 may be configured to determine a frequency offset between the transmitter network device and the receiver network device 400. In a non-limiting example, the PI 408 may support compensation for frequency offset up to 200 parts per million (ppm) from a frequency of the reference clock signal. The PI 408 may then rotate or adjust the digital signal 434 according to the determined frequency offset to synchronize the digital signal 434 with the reference clock signal. The digital signal 434 may then be forwarded to the data processing section 412.

The data processing section 412 may include a plurality of processing blocks for processing the digital signal 434. The plurality of processing blocks may include, for example, an equalization and gain control block, a CDR block, a slicing and data selection block, an error calculation and adaptive control block, or the like. The equalization and gain control block may further include, but not limited to, a short gain circuit, a short FFE circuit, a digital gain circuit, a long FFE circuit, or a Decision Feedback Equalizer (DFE) with slicer.

In the equalization and gain control block of the data processing section 412, the digital signal 434 may first pass through the short gain circuit, which may amplify the digital signal 434 to make the digital signal 434 fall within a configured amplitude range. In other words, the short gain circuit may amplify the digital signal 434 to compensate for attenuation introduced by the communication link. For example, the short gain circuit may provide a first-stage gain adjustment via a least mean squares (LMS) logic. The LMS logic may reduce ISI and may operate in conjunction with the short FFE circuit to address frequency-dependent signal degradation.

In an example, the short FFE circuit may refer to a linear equalizer that applies a finite impulse response (FIR) filter to the digital signal 434 to emphasize high-frequency components attenuated during transmission. The short FFE circuit may utilize one or more weighted coefficients (referred to as “one or more taps”) to compensate for different levels of ISI in the digital signal 434. The one or more taps may be adjusted adaptively using an LMS logic integrated in the short FFE circuit. The LMS logic may be configured to minimize ISI. In a non-limiting example, the short FFE circuit may utilize at least 6 taps. The digital gain circuit, coupled to the short FFE circuit, may provide additional amplitude scaling of the digital signal 434 before the digital signal 434 is provided to the long FFE circuit.

The long FFE circuit may implement scalable equalization modes such as 0, 9, 17 fixed taps, or the like, to support channel conditions of varying quality. In an example, 0 taps may refer to no equalization being applied on the digital signal 434 (utilized for very short and clean channels), 9 taps may refer to application of moderate equalization for medium-length channels, while 17 taps may refer to application of strong equalization for long and lossy channels. In numerous embodiments, the long FFE circuit may utilize floating taps that dynamically adjust or compensate the digital signal 434 for time-varying distortions. The floating taps, such as but not limited to, “2×4” taps may refer to two groups of four taps, each capable of adjusting its position in response to variations in the communication link. The long FFE circuit may thus fine-tune amplitude of the digital signal 434 before forwarding to the DFE with slicer circuit.

The DFE may be configured to apply symbol-based ISI cancellation by using previously detected symbols. The slicer may be configured to perform binary or multi-level decisions on the digital signal 434, and an output of the slicer may be fed back into the DFE to adjust future symbol decisions dynamically. The feedback mechanism may correct distortions caused by impairments in the communication link. The DFE may further optimize one or more tap coefficients to track channel variations. The output of the slicer (for example, a slicer out signal) may be forwarded as a first input signal to a mode select MUX in the data processing section 412.

The digital signal 434 from the ADC 404 may also be forwarded to an extra short reach (XSR) slicer for short-range interconnects, such as chip-to-chip or die-to-die, in the receiver network device 400. An output of the XSR slicer (for example, a short XSR slicer output signal) may be forwarded as a second input signal to the mode select MUX. Additionally, a short slicer, operating on the output of the short FFE circuit, may produce a third input for the mode select MUX.

The outputs of the DFE with slicer may be provided to the error calculation and adaptive control block, including an error correction circuit that determines deviation from expected values. The error calculation circuit may be configured to evaluate errors associated with the output of the DFE with slicer and provide feedback for gain and equalization adjustment to the digital gain circuit and the long FFE circuit. The errors may also be forwarded as one or more control signals to an RX state machine (SM), which manages mode transitions, such as between the power-down mode, an initialization mode, a training mode, the power-up or active power mode, or the like. An output of the XSR slicer may be forwarded to a PI control circuit in the receiver network device 400, which may determine phase adjustments to the digital signal 434. An output of the PI control circuit may be further forwarded as a first input to the switching element 414. Further, the output of the short slicer may be forwarded to a phase detector and CDR circuit, which may be configured to extract timing information to synchronize the first clock generator 406 with the received signal 430. The phase detector and CDR circuit accordingly may work with a second PI control circuit to make precise phase adjustments and obtain timing correction as an output. The timing correction may be forwarded as a second input signal to the switching element 414. The output 436 of the PI control circuit and the timing correction output are collectively shown as output 436 in FIG. 4.

Further, the mode select MUX may select one of the three input signals to the mode select MUX (for example, the first input signal or the second input signal or a third input signal) based on the conditions of the communication link. In an example scenario, the mode select MUX may forward the digital signal 434, to which FFE is applied, to the data decoding and output block. In such a scenario, the digital signal 434 may be decoded by the data decoding and output block and provided to the align circuit 416.

A portion of the received signal 430 (for example, signal 432) may also be received at the signal detector 410. Similarly, an end-of-transmission or idle sequence sent from the TX may be detected and configured to transition to a power-down mode of the RX. The signal detector 410 may be configured to identify one or more segments of a signal sequence in the received signal 430. In more embodiments, the signal sequence may include an initialization sequence, followed by a CDR lock pattern and a start bit identifier. The one or more segments of the signal sequence identified by the signal detector 410 may correspond to the initialization sequence, the CDR lock pattern, and the start bit identifier. The signal detector 410 may forward the CDR lock pattern and the start bit identifier to the second clock generator 424. In other words, the second clock generator 424 may remain idle unless the signal detector 410 identifies the initialization sequence. Upon the detection of the initialization sequence, the second clock generator 424 may receive a phase loop locked (PLL) lane clock signal of the receiving circuitry. Based on the CDR lock pattern and the PLL lane clock signal, the second clock generator 424 may generate a second clock signal that may be forwarded to the start bit detector 426 and the CDR lock circuit 428. Both the start bit detector 426 and the CDR lock circuit 428 may also receive the reference clock signal from the first clock generator 406 and the digital signal 434 output by the ADC 404. In a variety of embodiments, the second clock generator 424 may be configured to receive a signal 438 from the transmitter network device.

Based on the second clock signal and the reference clock signal, the start bit detector 426 may be configured to detect a start bit of the digital signal 434 while the CDR lock circuit 428 may be configured to rapidly acquire CDR lock and generate a locked current clock signal 440. The locked current clock signal 440 may be forwarded as the third input signal to the switching element 414. Based on at least one control signal associated with a time required for transitioning to the power-up mode by the receiver network device 400, the switching element 414 may select any one of the three input signals received by the switching element 414. The output 442 of the switching element 414 may be forwarded to the PI 408. The switching element 414 may correspond to a multiplexer, or the like.

Thus, when the transmitter network device transitions from the power-down mode to the power-up mode, the receiver network device 400 may receive the signal sequence from the transmitter network device and use the signal detector 410 of the receiving circuitry to identify at least the CDR lock pattern and the start bit identifier. The receiver network device 400 may then perform a CDR lock based on the received signal sequence and detect a start bit based on the CDR lock pattern. Based on at least one control signal received from the power management logic 422 for enabling rapid transition to the power-up mode, the switching element 414 may select the third input signal and thereby output the locked current clock signal 440 as an input to the PI 408.

The start bit detector 426 may further forward the detected start bit 446 to the align circuit 416 and to the PRBS checker 420. Thus, in additional embodiments, the receiver network device 400, may receive data over the communication link and align the received data based on the detected start bit 446. Accordingly, the received data may be processed into an equalized and decoded digital signal 444. The equalized and decoded digital signal 444 and the detected start bit 446 may be forwarded to the align circuit 416. The align circuit 416 may align the received equalized and decoded digital signal 444. That is to say, the align circuit 416 may shift data of the received equalized and decoded digital signal 444 based on the received detected start bit 446 and generate an aligned digital signal 448, which may be forwarded to the RX core I/F 418. The RX core I/F 418 may further process the aligned digital signal 448 and provide the processed aligned digital signal 450 to higher processing layers.

Although a specific embodiment for the receiver network device 400 suitable for carrying out the various steps, processes, methods, and operations described herein is discussed with respect to FIG. 4, any of a variety of systems and/or processes may be utilized in accordance with embodiments of the disclosure. For example, the PRBS checker 420 may be configured to validate the integrity of the received equalized and decoded digital signal 444 based on the received detected start bit 446 and generate an output signal 452 to check the signal quality of the digital signal 434. The detailed explanation for the embodiment is provided in the section below. The elements depicted in FIG. 4 may also be interchangeable with other elements of FIG. 1-3 and FIG. 5-11 as required to realize a particularly desired embodiment.

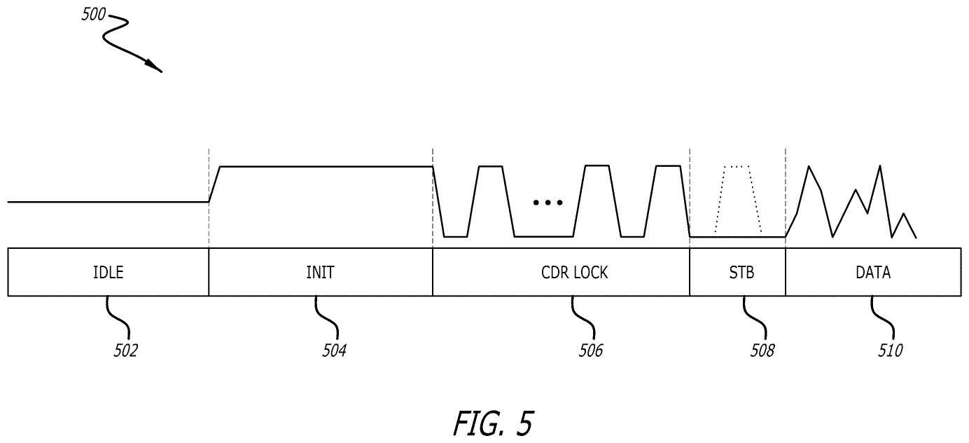

Referring to FIG. 5, a diagram that illustrates a signal sequence 500 in accordance with various embodiments of the disclosure is shown. The signal sequence 500 may be transmitted by a transmitter network device to a receiver network device over a communication link. In many embodiments, the signal sequence may be transmitted by the transmitter network device during, for example, a communication link startup, during a power-down to power-up transition phase, or the like. In a number of embodiments, the signal sequence 500 may include a plurality of segments, for example, an idle sequence 502 (referred to as “IDLE”) 502, an initialization sequence 504 (referred to as “INIT”) 504, a CDR lock pattern 506 (referred to as “CDR”), a start bit identifier 508 (referred to as “STB”), followed by actual payload data 510 (e.g., a data frame). Each of the plurality of segments of the signal sequence 500 may serve a distinct purpose in enabling fast wake-up, synchronization, and alignment of the receiver network device.

During the idle sequence 502, both the transmitter network device and the receiver network device may be in a power-down mode or in a low-power or inactive state, with no payload data being transmitted over the communication link. In an example, the idle sequence 502 may include a series of zero or zero voltage signals.

Based on a transition of the transmitter network device from the power-down mode to the power-up mode, the transmitter network device may transmit the initialization sequence 504 to wake up the receiver network device. The initialization sequence 504 may prepare the communication link for data transmission. Further, the change from the idle sequence 502 to the initialization sequence 504 may indicate a presence of transmission activity on the communication link, which may wake up the receive network device from the power-down mode.

The initialization sequence 504 may be followed by the CDR lock pattern 506. The CDR lock pattern 506 may enable one or more CDR circuits of the receiver network device to synchronize with the transmitter network device. In an example, the CDR lock pattern 506 may include repetitive bit sequences, for example, such as a C4 or C8 pattern, that enables the receiver network device to acquire frequency and phase lock with the transmitter network device.

Once the receiver network device achieves a stable lock via the CDR lock pattern, the transmitter network device may transmit the start bit identifier 508 in the signal sequence 500. The STB may refer to a signal or bit sequence that indicates the beginning of the payload data 510. The start bit identifier 508 may enable the receiver network device to differentiate between idle state and actual data transmission, ensuring proper synchronization. The receiver network device may lock a first bit of incoming data based on the start bit identifier 508. Once the receiver network device receives the start bit identifier 508, the transmitter network device may transmit the payload data 510. The receiver network device can now decode and process the payload data 510 correctly.

Although a specific embodiment for a signal sequence 500 suitable for carrying out the various steps, processes, methods, and operations described herein is discussed with respect to FIG. 5, any of a variety of systems and/or processes may be utilized in accordance with embodiments of the disclosure. For example, the transmitter network device may generate the signal sequence when a MAC layer in the transmitter network device generates a wake-up command. The elements depicted in FIG. 5 may also be interchangeable with other elements of FIG. 1-5 and FIG. 6-11 as required to realize a particularly desired embodiment.

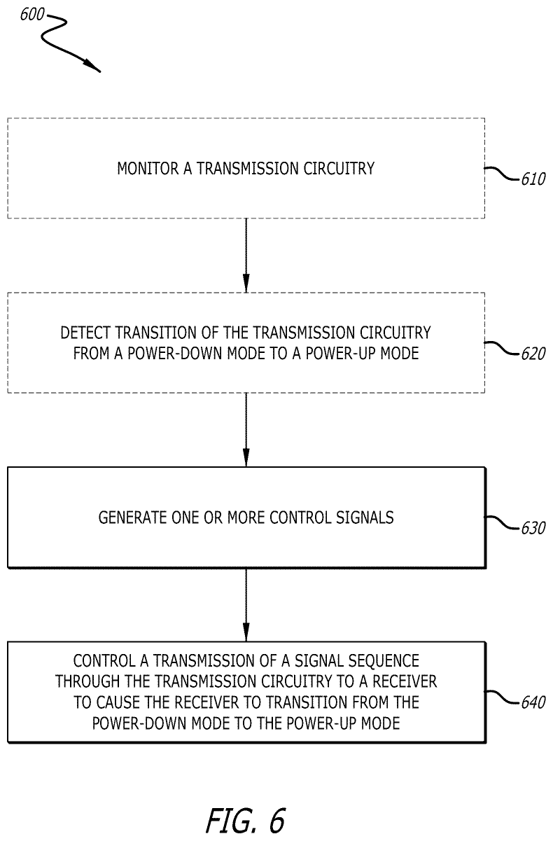

Referring to FIG. 6, a flowchart depicting a process 600 for enabling rapid transition of power modes in accordance with various embodiments of the disclosure is shown. In many embodiments, the rapid transition of power modes may be performed at an Ethernet interface of a transmitter network device. The transmitter network device may be coupled to a receiver network device via the Ethernet interface (e.g., a communication port) and a communication link. In an example, the process 600 may be performed by the transmitter network device that may have received a wake-up signal from a MAC layer associated with the transmitter network device.

In many embodiments, the process 600 may monitor a transmission circuitry (block 610). The transmission circuitry may be equipped inside the transmitter network device. In an example, the transmission circuitry may correspond to a SerDes transmitter circuit that may further include an input section, a first switching element, a FFE circuit, a second switching element, an output section, and a DAC, for example, as described in the foregoing description of FIG. 3.

In a number of embodiments, the process 600 may detect transition of the transmission circuitry from a power-down mode to a power-up mode (block 620). That is to say, the transmission circuitry may be in the power-down mode and may receive the wake-up signal from the MAC layer. Based on the wake-up signal, the transmission circuitry may transition from the power-down mode to the power-up mode. The power-down mode may be any inactive, idle or low power state of the transmitter network device during which most of the unused circuits of the transmission circuitry remain shut down. Whereas the power-up mode may refer to any active, high-power state of the transmission circuitry during which data transmission can take place via the Ethernet interface.

In more embodiments, the process 600 may generate one or more control signals (block 630). Based on the transition of the transmission circuitry from the power-down mode to the power-up mode, the one or more control signals may be generated to enable a rapid power transition of the transmitter network device, and in turn the receiver network device. In an example, the one or more control signals may be generated or updated during a transition phase of the transmission circuitry from the power-down mode to the power-up mode. In an example, the one or more control signals may include a first control signal coupled to the first switching element, a second control signal coupled to the second switching element, a third control signal coupled to the input section, and a fourth control signal coupled to the DAC.

In more embodiments, the process 600 may control a transmission of a signal sequence through the transmission circuitry to a receiver to cause the receiver to transition from the power-down mode to the power-up mode (block 640). In other words, the process 600 may control the transmission of the signal sequence through the transmission circuitry based on the generated one or more control signals. In several embodiments, the signal sequence may include a plurality of segments, such as an idle sequence, an initialization sequence, followed by a CDR lock pattern (e.g., preamble), and a start bit identifier. In various embodiments, the signal sequence may be configured to wake up the receiver network device from the power-down mode to the power-up mode, before transmission of actual data.

Although a specific embodiment for enabling rapid transition of power modes suitable for carrying out the various steps, processes, methods, and operations described herein is discussed with respect to FIG. 6, any of a variety of systems and/or processes may be utilized in accordance with embodiments of the disclosure. For example, the process 600 may generate one or more control signals for a rapid power mode transition from a power-up mode to a power-down mode. The elements depicted in FIG. 6 may also be interchangeable with other elements of FIG. 1-5 and FIG. 6-11 as required to realize a particularly desired embodiment.

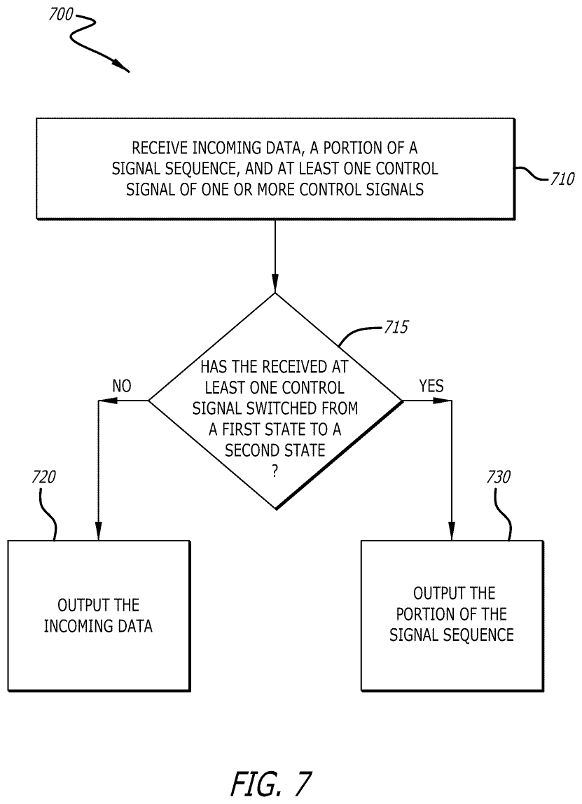

Referring to FIG. 7, a flowchart depicting a process 700 for implementing a selection of an output signal in accordance with various embodiments of the disclosure is shown. In many embodiments, the selection and generation of an output signal may be performed by a first switching element. In an example, the first switching element may be equipped in an Ethernet interface of a transmitter network device. Examples of the transmitter network device may include a router, a switch, a hub, a modem, an access point, a server, a computing node, or the like. In many embodiments, the first switching element may correspond to a MUX. Further, the first switching element may be coupled between an input section and an FFE circuit in a transmission path of the Ethernet interface.

In various embodiments, the process 700 may receive incoming data, a portion of a signal sequence, and at least one control signal of one or more control signals (block 710). For example, the first switching element may be configured to receive the incoming data at a first input terminal and the portion of the signal sequence at a second input terminal. The first switching element may further be configured to receive the at least one control signal at a control terminal. Based on the received at least one control signal, the first switching element may be configured to output at an output terminal one of the incoming data or the received portion of the signal sequence.

In a number of embodiments, the process 700 may determine whether the received at least one control signal has switched from a first state to a second state (block 715). The process 700 may monitor the state of the at least one control signal for any transition from the first state to the second state, or vice versa. The transition may be any voltage level shift, logic high-to-low or low-to-high change, or a specific bit pattern alteration. For example, the first state may be a low voltage level, and the second state may be a high voltage level or vice versa.

If the received at least one control signal has not switched from the first state to the second state, in more embodiments, the process 700 may output the incoming data (block 720). In other words, if the received at least one control signal at the control terminal is at the first state, the first switching element may be configured to select a signal from the first input terminal which is the incoming data and provide the selected signal as an output of the first switching element.

However, if the received at least one control signal switches from the first state to the second state, in yet more embodiments, the process 700 may output the portion of the signal sequence (block 730). The portion of the signal sequence may be an initialization sequence, a CDR lock pattern, or a start bit identifier. The portion of the signal sequence may be provided as an output of the first switching element to enable link training of the communication link and also synchronize the receiver network device after waking up from the power-down mode.

Although a specific embodiment for implementing selection of an output signal suitable for carrying out the various steps, processes, methods, and operations described herein is discussed with respect to FIG. 7, any of a variety of systems and/or processes may be utilized in accordance with embodiments of the disclosure. For example, the process 700 may continue outputting the portion of the signal sequence as long as the received at least one control signal remains at the second state. The elements depicted in FIG. 7 may also be interchangeable with other elements of FIG. 1-5 and FIG. 7-11 as required to realize a particularly desired embodiment.

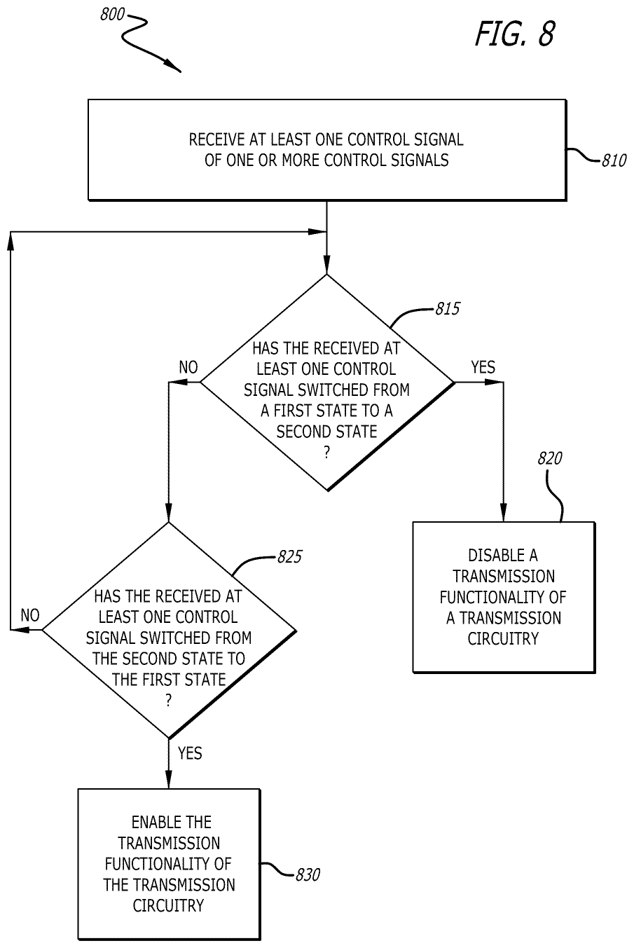

Referring to FIG. 8, a flowchart depicting a process 800 for switching to a selected output signal in accordance with various embodiments of the disclosure is shown. In many embodiments, the process 800 may be performed by a power management logic configured to control one or more select lines of a second switching element. The power management logic as well as the second switching element may be included in a transmitter network device. The second switching element may correspond to a MUX. Further, the second switching element may be coupled between an FFE circuit and an output section of the transmitter network device.

In many embodiments, the process 800 may receive at least one control signal of one or more control signals (block 810). The process 800 may generate the at least one control signal to control a transmission path or a transmission circuitry of the transmitter network device. Accordingly, the second switching element may be configured to receive the generated at least one control signal to disable or enable a transmission functionality of the transmission circuitry.

In a number of embodiments, the process 800 may determine whether the received at least one control signal has switched from a first state to a second state (block 815). The process 800 may track the status of the at least one control signal to detect any shift from the first state to the second state. This transition may involve a change in voltage levels, a shift from logic low to high or high to low, or a modification in a specific bit pattern. For example, the first state may correspond to a low voltage level, while the second state could represent a high voltage level, or the reverse.

If the received at least one control signal switches from the first state to the second state, in more embodiments, the process 800 may disable the transmission functionality of the transmission circuitry (block 820). In various aspects, disabling the transmission functionality of the transmission circuitry may involve decoupling the FFE circuit from the output section.

However, if the received at least one control signal has not switched from the first state to the second state, in yet more embodiments, the process 800 may determine whether the received at least one control signal has switched from the second state to the first state (block 825). A transition from the second state to the first state in the received at least one control signal at a control terminal of the second switching element may trigger the second switching element couple the FFE circuit to the output section. If the process 800 determines that the received at least one control signal has also not switched from the second state to the first state, the process 800 may again monitor the received at least one control signal (block 815).

If the process 800 determines that the received at least one control signal has switched from the second state to the first state, in still more embodiments, the process 800 may enable the transmission functionality of the transmission circuitry (block 830). A transition from the second state to the first state in the received at least one control signal at a control terminal of the second switching element may trigger the second switching element couple the FFE circuit to the output section, which enables the transmission functionality of the transmission circuitry. Enabling the transmission functionality may allow the transmission circuitry to transmit the portion of the signal sequence or the incoming data to the receiver network device.

Although a specific embodiment for switching to a selected output signal suitable for carrying out the various steps, processes, methods, and operations described herein is discussed with respect to FIG. 8, any of a variety of systems and/or processes may be utilized in accordance with embodiments of the disclosure. For example, the process 800 may enable a rapid transition of the transmission circuitry to a power-down mode from a power-up mode by changing the state of the at least one control state to the second state. Upon changing the state of the at least one signal to the second state, the second switching element may select the idle sequence that may become an output of a digital section of the transmission circuitry. Thus, the process 800 may set the output of the digital section to zero via the idle sequence before turning off the transmitter network device completely. The elements depicted in FIG. 8 may also be interchangeable with other elements of FIG. 1-7 and FIG. 9-11 as required to realize a particularly desired embodiment.

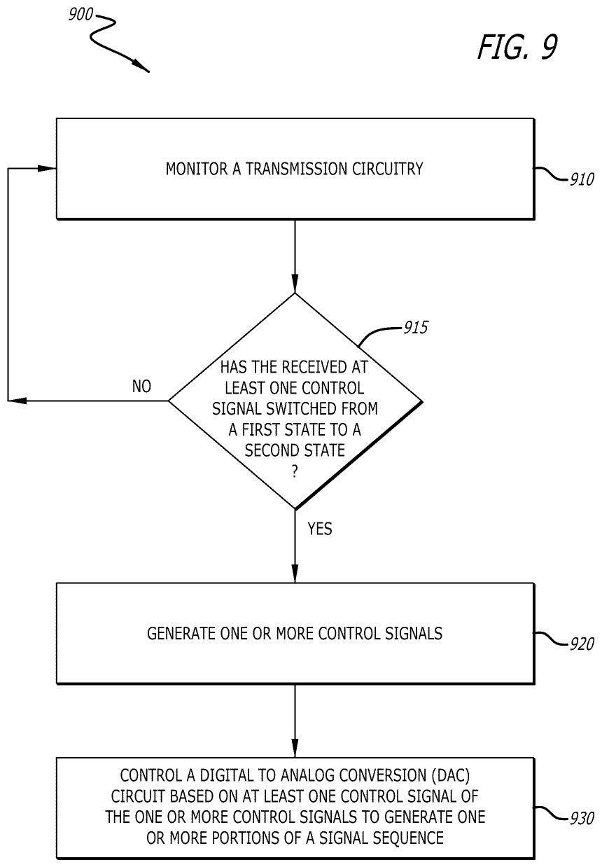

Referring to FIG. 9, a flowchart depicting a process 900 for generating control signals in accordance with various embodiments of the disclosure is shown. In many embodiments, the process 900 may be performed by a transmitter network device implementing an Ethernet interface. In additional embodiments, the process 900 may monitor a transmission circuitry (block 910). The transmission circuitry may be equipped in the transmitter network device and may be configured to enable the functionality of the transmitter network device to process data and transmit the processed data.

In numerous embodiments, the process 900 may determine whether the transmission circuitry transitioned from a power-down mode to a power-up mode (block 915). The power-down mode may correspond to a low power state, a standby mode, or a sleep mode of the transmitter network device. The power-up mode may correspond to an active mode, a high-power mode, or an operational mode of the transmitter network device. The power transition may thus be a change of the power mode of the transmitter network device from the power-down or low-power (OFF/IDLE) mode to the power-up or high-power (ON/ACTIVE) mode.

If the transmission circuitry has transitioned from the power-down mode to the power-up mode, in a variety of embodiments, the process 900 may generate one or more control signals (block 920). The one or more control signals may be generated in order to facilitate a quick transitioning of the transmitter network device to the power-up mode. At least one control signal of the generated one or more control signals may be an analog control signal. However, if the transmission circuitry has not transitioned from the power-down mode to the power-up mode, the process 900 may continue monitoring the transition circuitry (block 910).

If the transmission circuitry has transitioned from the power-down mode to the power-up mode, in further additional embodiments, the process 900 may control a DAC circuit based on the at least one control signal of the one or more control signals to generate one or more portions of a signal sequence (block 930). In numerous embodiments, controlling the DAC circuit may correspond to waking up the DAC circuit while digital section of the transmission circuitry is still undergoing a power-up sequence to transition to the power-up mode. Thus, based on the rapid wake up of the DAC circuit in response to the at least one control signal, the DAC circuit may be configured to generate the one or more portions of the signal sequence, for example, an initialization sequence. The initialization sequence may be configured to cause the receiver network device to rapidly wake up from the power-down mode and be ready for synchronization.

Although a specific embodiment for generating control signals suitable for carrying out the various steps, processes, methods, and operations described herein is discussed with respect to FIG. 9, any of a variety of systems and/or processes may be utilized in accordance with embodiments of the disclosure. For example, the process 900 may generate one or more control signals to transition the transmission circuitry rapidly from the power-up mode to the power-down mode. Controlling the DAC circuit may correspond to shutting the DAC circuit while the digital section of the transmission circuitry is still undergoing a power-down sequence to transition to the power-down mode. The elements depicted in FIG. 9 may also be interchangeable with other elements of FIGS. 1-8 and FIG. 10-11 as required to realize a particularly desired embodiment.

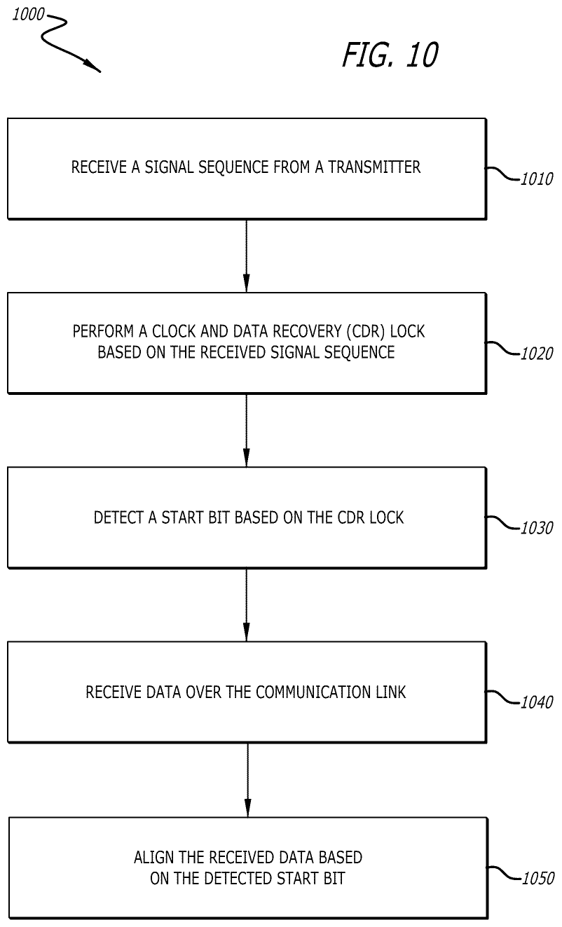

Referring to FIG. 10, a flowchart depicting a process 1000 for managing a rapid power mode transition in accordance with various embodiments of the disclosure is shown. In many embodiments, the process 1000 may be performed by a receiver network device implementing an Ethernet interface, for example, a SerDes receiver interface. The receiver network device may be equipped with a power management logic for managing a rapid transition of power mode of receiving circuitry of the receiver network device. In many embodiments, the process 1000 may receive a signal sequence from a transmitter (block 1010). In more embodiments, the receiver network device may be coupled to the transmitter over a communication link. In various embodiments, the signal sequence may include an initialization sequence, followed by a CDR lock pattern and a start bit identifier. Examples of the CDR lock pattern may include a C8 or a C4 clock pattern.

In additional embodiments, the process 1000 may perform a CDR lock based on the received signal sequence (block 1020). In numerous embodiments, the process 1000 may extract timing characteristics from the CDR lock pattern. Further, the process 1000 may analyze the extracted timing characteristics of the received signal sequence. The CDR lock pattern may provide consistent transitions that allow the process 1000 to synchronize an internal sampling clock with an incoming data stream. This synchronization may enable accurate timing alignment for subsequent data decoding.

In a number of embodiments, the process 1000 may detect a start bit based on the CDR lock (block 1030). Once the process 1000 acquires the CDR lock, the process 1000 may analyze the incoming data for a distinct pattern that may correspond to a distinct voltage transition, edge pattern, or a specific bit sequence that marks the start bit. The start bit may be detected by a start bit detector equipped in the receiving circuitry.

In a variety of embodiments, the process 1000 may receive data over the communication link (block 1040). Once the receiver network device is synchronized with the transmitter network device, the receiver network device may start receiving the data over communication link. In an example, the received data may be an analog signal which may be converted to a digital signal at the receiver network device by an ADC in the receiving circuitry. The digital signal of the data may be further processed by the receiver network device.

In additional embodiments, the process 1000 may align the received data based on the detected start bit (block 1050). Aligning the received data based on the detected start bit may involve shifting the receive data to a bit position indicated by the detected start bit. If the received data is misaligned due to transmission delays or clock drift, the process 1000 may shift the received data to reposition at the expected start bit. The alignment of the received data may enable remaining bits in the received data to be sampled accurately relative to a clock cycle locked by the CDR lock pattern.

Although a specific embodiment for managing a rapid power mode transition suitable for carrying out the various steps, processes, methods, and operations described herein is discussed with respect to FIG. 10, any of a variety of systems and/or processes may be utilized in accordance with embodiments of the disclosure. For example, if the transmitter network device transitions to a power-down mode due to absence of data, the process 1000 may receive a signal sequence includes an idle sequence transmitted by the transmitter network device. The process 1000 may initiate a power-down sequence to transition the receiver network device or the receiving circuitry in the receiver network device to the power-down mode, based on the signal sequence including the idle sequence. The elements depicted in FIG. 10 may also be interchangeable with other elements of FIG. 1-9 and FIG. 11 as required to realize a particularly desired embodiment.

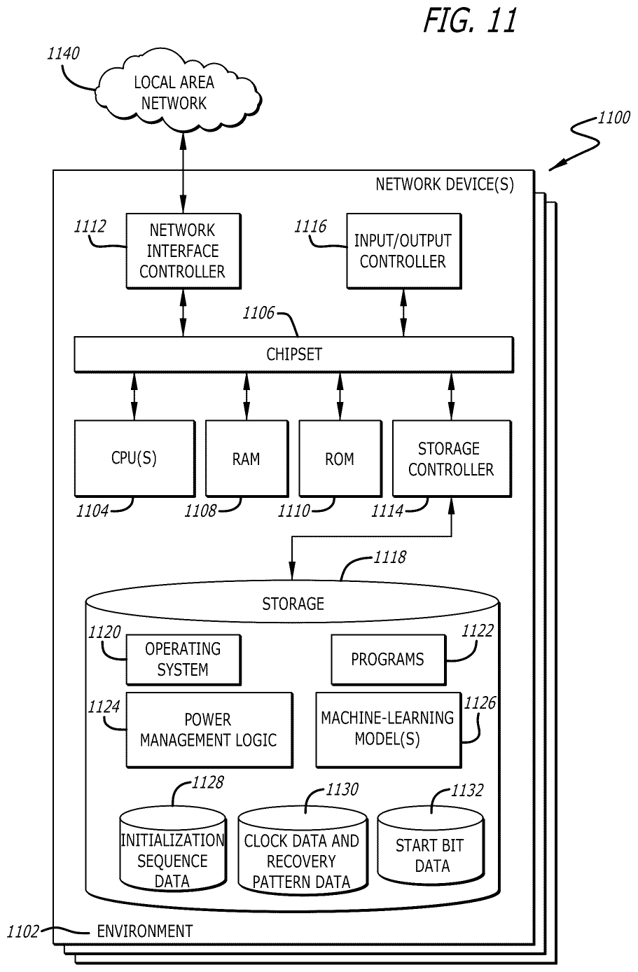

Referring to FIG. 11, a conceptual block diagram of a device 1100 suitable for configuration with a power management logic in accordance with various embodiments of the disclosure is shown. The embodiment of the conceptual block diagram depicted in FIG. 11 can illustrate a conventional server, switch, wireless LAN controller, AP, computer, workstation, desktop computer, laptop, tablet, network appliance, e-reader, smartphone, or other computing device, an ethernet interface, and can be utilized to execute any of the application and/or logic components presented herein. The embodiment of the conceptual block diagram depicted in FIG. 11 can also illustrate an AP, a switch, an edge node, an ethernet interface, or a router in accordance with various embodiments of the disclosure. The device 1100 may, in many non-limiting examples, corresponds to physical devices or virtual resources described herein.

In many embodiments, the device 1100 may include an environment 1102 such as a baseboard or “motherboard,” in physical embodiments that can be configured as a printed circuit board with a multitude of components or devices connected by way of a system bus or other electrical communication paths. Conceptually, in virtualized embodiments, the environment 1102 may be a virtual environment that encompasses and executes the remaining components and resources of the device 1100. In more embodiments, one or more processors 1104, such as, but not limited to, central processing units (“CPUs”) can be configured to operate in conjunction with a chipset 1106. The processor(s) 1104 can be standard programmable CPUs that perform arithmetic and logical operations necessary for the operation of the device 1100. In a number of embodiments, the processor(s) 1104 can perform one or more operations by transitioning from one discrete, physical mode to the next through the manipulation of switching elements that differentiate between and change these modes. Switching elements generally include electronic circuits that maintain one of two binary modes, such as flip-flops, and electronic circuits that provide an output mode based on the logical combination of the modes of one or more other switching elements, such as logic gates. These basic switching elements can be combined to create more complex logic circuits, including registers, adders-subtractors, arithmetic logic units, floating-point units, and the like.

In various embodiments, the chipset 1106 may provide an interface between the processor(s) 1104 and the remainder of the components and devices within the environment 1102. The chipset 1106 can provide an interface to a random-access memory (“RAM”) 1108, which can be used as the main memory in the device 1100 in some embodiments. The chipset 1106 can further be configured to provide an interface to a computer-readable storage medium such as a read-only memory (“ROM”) 1110 or non-volatile RAM (“NVRAM”) for storing basic routines that can help with various tasks such as, but not limited to, starting up the device 1100 and/or transferring information between the various components and devices. The ROM 1110 or NVRAM can also store other application components necessary for the operation of the device 1100 in accordance with various embodiments described herein.

Additional embodiments of the device 1100 can be configured to operate in a networked environment using logical connections to remote computing devices and computer systems through a network, such as the network 1140. The chipset 1106 can include functionality for providing network connectivity through a network interface card (“NIC”) 1112, which may comprise a gigabit Ethernet adapter or similar component. The NIC 1112 can be capable of connecting the device 1100 to other devices over the network 1140. It is contemplated that multiple NICs 1112 may be present in the device 1100, connecting the device to other types of networks and remote systems.

In further embodiments, the device 1100 can be connected to a storage 1118 that provides non-volatile storage for data accessible by the device 1100. The storage 1118 can, for instance, store an operating system 1120 and programs 1122 (for example, applications). The storage 1118 can be connected to the environment 1102 through a storage controller 1114 connected to the chipset 1106. In various other embodiments, the storage 1118 can consist of one or more physical storage units. The storage controller 1114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1100 can store data within the storage 1118 by transforming the physical mode of the physical storage units to reflect the information being stored. The specific transformation of physical mode can depend on various factors. Examples of such factors can include, but are not limited to, the technology used to implement the physical storage units, whether the storage 1118 is characterized as primary or secondary storage, and the like.

In many more embodiments, the device 1100 can store information within the storage 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-mode storage unit, or the like. Other transformations of physical media are possible without departing from the scope and spirit of the present description, with the foregoing examples provided only to facilitate this description. The device 1100 can further read or access information from the storage 1118 by detecting the physical modes or characteristics of one or more particular locations within the physical storage units.

In addition to the storage 1118 described above, the device 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1100. In some examples, the operations performed by a cloud computing network, or any components included therein, may be supported by one or more devices similar to device 1100. Modeled otherwise, some or all of the operations performed by the cloud computing network, or any components included therein, may be performed by one or more devices 1100 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-mode memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1118 can store an operating system 1120 utilized to control the operation of the device 1100. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1118 can store other system or application programs and data utilized by the device 1100.

In many additional embodiments, the storage 1118 or other computer-readable storage media is encoded with computer-executable instructions which, when loaded into the device 1100, may transform it from a general-purpose computing system into a special-purpose computer capable of implementing the embodiments described herein. These computer-executable instructions may be stored as programs 1122 (for example, an application) and transform the device 1100 by specifying how the processor(s) 1104 can transition between modes, as described above. In some embodiments, the device 1100 has access to computer-readable storage media storing computer-executable instructions which, when executed by the device 1100, perform the various processes described above with regard to FIG. 1-10. In certain embodiments, the device 1100 can also include computer-readable storage media having instructions stored thereupon for performing any of the other computer-implemented operations described herein.

In many further embodiments, the device 1100 may include a power management logic 1124. The power management logic 1124 can be configured to perform one or more of the various steps, processes, operations, and/or other methods that are described above. Often, the power management logic 1124 can be a set of instructions stored within a non-volatile memory that, when executed by the processor(s) 1104 can carry out these steps, etc. In some embodiments, the power management logic 1124 may be a client application that resides on a network-connected device, such as, but not limited to, a server, switch, an ethernet interface, personal or mobile computing device in a single or distributed arrangement. The power management logic 1124 may be configured to manage a rapid transition of power modes from a power-down mode to a power-down up, or vice versa. The device 1100 herein may be a transmitter network device. The power management logic 1124 may be further configured to generate one or more control signals based on a transition of a transmission circuitry of the device 1100 from a power-down mode to a power-up mode and control a transmission of a signal sequence through the transmission circuitry to a receiver based on the one or more control signals. The signal sequence may be configured to cause a receiver device coupled to the device 1100 to transition from the power-down mode to the power-up mode.

In several other embodiments, the power management logic 1124 may be included in a receiver network device. In such a scenario, the device 1100 may be the receiver network device. The power management logic 1124 may receive the signal sequence from a transmitter and perform a CDR lock based on the received signal sequence. The power management logic 1124 may further detect a start bit based on the CDR lock. A receiving circuitry associated with the device 1100 may be configured to receive data over the communication link and align the received data based on the detected start bit.

In some embodiments, the storage 1118 can include initialization sequence data 1128. The initialization sequence data 1128 may refer to predefined signal patterns used to establish communication between the transmitter and the receiver, ensuring that both the transmitters and the receiver are synchronized before actual data transmission begins. The initialization sequence data 1128 may include training sequences, calibration data, or handshake signals that configure equalization settings and phase adjustments of the receiver. For example, the initialization sequence data 1128 may include predefined sequences such as K28.5 (comma character) in 8 b/10 b encoding or training sequences (for example, Pseudo-Random Binary Sequences “PRBS”) used in the Ethernet interface.

In various embodiments, the storage 1118 can include CDR pattern data 1130. The CDR pattern data 1130 may refer to a structured bit sequence designed to aid a CDR circuit in the receiver in locking onto a timing of an incoming signal. The CDR pattern data 1130 may help extract an embedded clock signal to ensure that the receiver accurately samples the transmitted data at the correct intervals. The CDR pattern data 1130 may consist of alternating ‘101010 . . . ’ patterns or scrambled PRBS sequences, C4 or C8 sequences.

In a number of embodiments, the storage 1118 can include start bit data 1132. The start bit data 1132 may refer to a specific bit pattern or sequence that may point to a beginning of a valid data frame, serving as a synchronization point for aligning received bits. The start bit data 1132 may ensure that incoming data is interpreted correctly by defining a clear boundary between idle or synchronization sequences and actual transmitted data. Fo example, in an Ethernet packet transmission, a Start Frame Delimiter “SFD” (for example, 10101011 in 8 b/10 b encoding) may correspond to start bit data 1132 that may mark a valid Ethernet frame after the preamble.

In still further embodiments, the device 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can be configured to provide output to a display, such as a computer monitor, a flat panel display, a digital projector, a printer, or other type of output device. Those skilled in the art will recognize that the device 1100 might not include all of the components shown in FIG. 11 and can include other components that are not explicitly shown in FIG. 11 or might utilize an architecture completely different than that shown in FIG. 11.

As described above, the device 1100 may support a virtualization layer, such as one or more virtual resources executing on the device 1100. In some examples, the virtualization layer may be supported by a hypervisor that provides one or more virtual machines running on the device 1100 to perform functions described herein. The virtualization layer may generally support a virtual resource that performs at least a portion of the techniques described herein.

Finally, in numerous additional embodiments, data may be processed into a format usable by a ML model 1126 (for example, feature vectors), or other pre-processing techniques. The ML model 1126 may be any type of ML model, such as supervised models, reinforcement models, and/or unsupervised models. The ML model 1126 may include one or more of linear regression models, logistic regression models, decision trees, Naïve Bayes models, neural networks, k-means cluster models, random forest models, and/or other types of ML models 1126. In an example, the ML model 1126 may include the plurality of classifiers, each trained for a specific task such as error correction and encoding or decoding of one or more data frames transmitted before and after power transitioning phase by the device, that share common encoder(s).

The ML model(s) 1126 can be configured to generate inferences to make predictions or draw conclusions from data. An inference can be considered the output of a process of applying a model to new data. This can occur by learning from at least the initialization sequence data 1128, the CDR pattern data 1130, and the start bit data 1132. These predictions are based on patterns and relationships discovered within the data. To generate an inference, the trained model can take input data and produce a classification result. The input data can be in various forms, such as images, audio, text, or numerical data, network packet data, or an Ethernet packet data depending on the type of problem the model was trained to solve. The output of the model can also vary depending on the problem, and can be a single number, a probability distribution, a set of labels, a decision about an action to take, etc. Ground truth for the ML model(s) 1126 may be generated by human/administrator verifications or may compare predicted outcomes with actual outcomes. Further, the ML model(s) 1126 may be configured to process the incoming data based on the CDR pattern data 1130 and the start bit data 1132. For example, the ML model(s) 1126 may align or shift the incoming data based on the start bit data 1132 once a clock signal of the receiver is locked based on the CDR pattern data 1130. By learning from the initialization sequence data 1128, the CDR recovery data 1130 and the start bit data 1132, the ML model(s) 1126 can predict at least one control signal that needs to be generated for a rapid transition of a power-down mode to a power-up mode or vice versa. In other words, once trained, the ML model(s) 1126 may be further deployed on the device 1100 (for example, a transmitter, a receiver, a remitter, a transceiver, a communication port or the like) for managing a rapid power transition capability in the Ethernet interface.

Although a specific embodiment for a device suitable for configuration with the power management logic for carrying out the various steps, processes, methods, and operations described herein is discussed with respect to FIG. 11, any of a variety of systems and/or processes may be utilized in accordance with embodiments of the disclosure. For example, the device 1100 may be in a virtual environment such as a cloud-based network administration suite, or it may be distributed across a variety of network devices or APs. The elements depicted in FIG. 11 may also be interchangeable with other elements of FIG. 1-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or different computing devices) in order to achieve similar results in a manner that is more appropriate to the requirements of a specific application. It is therefore to be understood that the present disclosure can be practiced other than specifically described without departing from the scope of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so mentioned, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the scope of the present disclosure, as set forth in the appended claims, as might be apparent to those of ordinary skill in the art, are also encompassed by the present disclosure.

What is claimed is:

1. A network device, comprising:
transmission circuitry communicatively coupled to a receiver over a communication link; and
a power management logic configured to:
generate one or more control signals based on a transition of the transmission circuitry from a power-down mode to a power-up mode or from the power-up mode to the power-down mode; and
control a transmission of a signal sequence through the transmission circuitry to the receiver based on the one or more control signals, wherein the signal sequence is configured to cause the receiver to transition from the power-down mode to the power-up mode.

2. The network device of claim 1, wherein the transmission circuitry corresponds to a Serializer/Deserializer transmitter.

3. The network device of claim 1, wherein the signal sequence comprises an initialization sequence, followed by a Clock and Data Recovery (CDR) lock pattern and a start bit identifier.

4. The network device of claim 1, wherein the transmission circuitry comprises:
an input section;
a feed-forward equalizer circuit; and
a first switching element coupled between the input section and the feed-forward equalizer circuit, wherein the first switching element is configured to receive at least one control signal of the generated one or more control signals.

5. The network device of claim 4, wherein the first switching element comprises:
a first input terminal, coupled to the input section, is configured to receive incoming data;
a second input terminal configured to receive a portion of the signal sequence; and
an output terminal coupled to the feed-forward equalizer circuit, wherein the first switching element is further configured to output at the output terminal one of the incoming data or the received portion of the signal sequence based on the received at least one control signal.

6. The network device of claim 5, wherein the first switching element is further configured to output the received portion of the signal sequence based on the received at least one control signal switching from a first state to a second state.

7. The network device of claim 5, wherein the received portion of the signal sequence corresponds to at least one of a Clock and Data Recovery (CDR) lock pattern or a start bit identifier.

8. The network device of claim 4, wherein the first switching element comprises a multiplexer.

9. The network device of claim 1, wherein the transmission circuitry comprises:
an output section;
a feed-forward equalizer circuit; and
a second switching element coupled between the output section and the feed-forward equalizer circuit, wherein the second switching element is configured to receive at least one control signal of the generated one or more control signals.

10. The network device of claim 9, wherein the second switching element is configured to control a transmission functionality of the transmission circuitry based on the received at least one control signal.

11. The network device of claim 10, wherein the controlling of the transmission functionality of the transmission circuitry comprises disabling the transmission functionality of the transmission circuitry based on the received at least one control signal switching from a first state to a second state.

12. The network device of claim 11, wherein the disabling of the transmission functionality of the transmission circuitry occurs in the transition to power-down mode.

13. The network device of claim 10, wherein the controlling of the transmission functionality of the transmission circuitry comprises enabling the transmission functionality of the transmission circuitry based on the received at least one control signal switching from a second state to a first state.

14. The network device of claim 10, wherein the transmission functionality of the transmission circuitry occurs in the transition to power-up mode.

15. The network device of claim 9, wherein the second switching element comprises a multiplexer.

16. The network device of claim 9, wherein the transmission circuitry further comprises a digital to analog conversion (DAC) circuit, coupled to the output section, that is configured to generate one or more portions of the signal sequence based on a control signal of the generated one or more control signals.

17. The network device of claim 16, wherein the one or more portions of the signal sequence comprises an initialization sequence.

18. A network device, comprising:
receiving circuitry communicatively coupled to a transmitter over a communication link; and
a power management logic configured to:
receive a signal sequence from the transmitter;
perform a clock and data recovery (CDR) lock based on the received signal sequence; and
detect a start bit based on the CDR lock, wherein the receiving circuitry is configured to:
receive data over the communication link; and
align the received data based on the detected start bit.

19. The network device of claim 18, wherein the signal sequence comprises an initialization sequence, followed by a Clock and Data Recovery (CDR) lock pattern and a start bit identifier.

20. A method in a transmitter device, comprising:
generating one or more control signals based on a transition of a transmission circuitry of the transmitter device from a power-down mode to a power-up mode; and
controlling a transmission of a signal sequence through the transmission circuitry to a receiver based on the one or more control signals, wherein the signal sequence is configured to cause the receiver to transition from the power-down mode to the power-up mode.
